(19) United States
(12) Patent Application Publication
(10) Pub. No.: US 2026/0181646 A1
(43) Pub. Date: Jun. 25, 2026

(54) METHOD, USER EQUIPMENT AND ACCESS NETWORK NODE

(71) Applicant: NEC Corporation, Minato-ku, Tokyo (JP)

(72) Inventors: Yuhua CHEN, London (GB); Hisashi FUTAKI, Tokyo (JP)

(73) Assignee: NEC Corporation, Minato-ku, Tokyo (JP)

(21) Appl. No.: 19/121,232

(22) PCT Filed: Oct. 30, 2023
(86) PCT No.: PCT/JP2023/039031

§ 371 Date: Apr. 15, 2025

(30) Foreign Application Priority Data
Nov. 3, 2022 (GB) 2216395.0

(51) Int. Cl. H04W 72/23

(52) U.S. Cl. CPC H04W 72/23

(57) ABSTRACT

A communication system 1 is disclosed in which a user equipment (UE) 3 receives information for configuring resource sets for use when initiating a random access procedure with Msg3 repetition and information for configuring a condition for initiation random access procedure with Msg3 repetition. The information for configuring the condition defines a plurality of different thresholds to be used when determining whether to initiate a random access procedure with Msg3 repetition.

### TECHNICAL FIELD

The present invention relates to a communication system.

### BACKGROUND ART

The present disclosure relates to a wireless communication system and devices thereof operating according to the 3rd Generation Partnership Project (3GPP) standards or equivalents or derivatives thereof. The disclosure has particular but not exclusive relevance to improvements relating to random access procedures in the so-called ‘5G’ (or ‘Next Generation (NG)’ or ‘New Radio’ (NR)) systems, in particular in (but not limited to) the context of Non-Terrestrial Networks (NTN).

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 and 3GPP TS 37.340 define the following nodes, amongst others:
gNB: node providing NR user plane and control plane protocol terminations towards the UE and connected via the NG interface to the 5G core network (5GC);
ng-eNB: node providing Evolved Universal Terrestrial Radio Access (E-UTRA) user plane and control plane protocol terminations towards the UE and connected via the NG interface to the 5GC;
En-gNB: node providing NR user plane and control plane protocol terminations towards the UE and acting as Secondary Node in E-UTRA-NR Dual Connectivity (EN-DC); and
NG-RAN node: either a gNB or an ng-eNB.

3GPP is also working with the satellite communication industry to specify an integrated satellite and terrestrial network infrastructure in the context of 5G. This is referred to as non-terrestrial networks (NTN) which term refers to networks, or segments of networks, using an airborne or spaceborne vehicle for transmission of data and control signalling. Satellites refer to spaceborne vehicles in Low Earth Orbits (LEO), Medium Earth Orbits (MEO), Geostationary Earth Orbit (GEO) or in Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 is a study on New Radio to support such on-terrestrial networks. The study includes, amongst other things, NTN deployment scenarios and related system parameters (such as architecture, altitude, orbit etc.) and a description of adaptation of the 3GPP channel models for non-terrestrial networks (propagation conditions, mobility, etc.). Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

Non-Terrestrial Network access typically features the following elements (amongst others):
NTN Terminal: This may refer to the 3GPP UE or to a UE specific to the satellite system in the case that the satellite does not serve directly 3GPP UEs;
A service link which refers to the radio link between the user equipment and the space/airborne platform (which may be in addition to a radio link with a terrestrial based RAN);
A space or an airborne platform;
Gateways that connect the satellite or aerial access network to the core network. It will be appreciated that gateways will mostly likely be collocated with a base station (e.g. a gNB);
Feeder links which refer to the radio links between the Gateways and the space/airborne platform.

Satellite or aerial vehicles typically generate several satellite beams over a given area. The beams have a typically elliptic footprint on the surface of the earth. The beam footprint may be moving over the earth with the satellite or the aerial vehicle motion on its orbit. Alternatively, the beam footprint may be earth fixed (albeit temporarily), in such case some beam pointing mechanisms (mechanical or electronic steering feature) may be used to compensate for the satellite or the aerial vehicle motion.

The coverage in 5G is primarily beam-based rather than cell based. There is no cell-level reference channel from where the coverage of the cell could be measured. Instead, each cell has one or more so-called synchronization signal block (SSB) beams (which are different to satellite or NTN beams). SSB beams form a matrix of beams covering an entire cell area. Each SSB beam carries an SSB comprising a primary synchronization signal (PSS), secondary synchronization signal (SSS), and physical broadcast channel (PBCH).

The UE searches for and performs measurements on the SSB beams (e.g. of the synchronization signal reference signal received power, ‘SS-RSRP’, synchronization signal reference signal received quality, ‘SS-RSRQ’, and/or the synchronization signal to noise or interference ratio, ‘SS-SINR’). The UE maintains a set of candidate beams which may contain beams from multiple cells. A physical cell ID (PCI) and beam ID (or SSB index) thus distinguish the beams from each other. Effectively, therefore, the SSB beams are like mini cells which may be within a larger cell. Once a UE has detected and selected a cell (and/or an SSB beam in the case of 5G) it may attempt to access that cell and/or SSB beam using an initial radio resource control (RRC) connection setup procedure comprising a random access procedure.

For example, once a UE has detected and selected a cell (and/or a beam in the case of 5G) it may attempt to access that cell and/or beam using an initial radio resource control (RRC) connection setup procedure comprising a random access procedure that typically involves four distinct steps. In the case of 5G prior to attempting initial access the UE may perform transmission of a preamble to the network (e.g. a base station such as a gNB) over a physical random access channel (PRACH) for initiating a process to obtaining synchronization in the uplink (UL). This step is often referred to as PRACH transmission or simply transmission of message 1 (Msg1). In response, the network responds with a random access response (RAR). The RAR indicates reception of the preamble and includes: a timing-alignment (TA) command for adjusting the transmission timing of the UE based on the timing of the received preamble; an uplink grant field indicating the resources to be used in the uplink for a physical uplink shared channel (PUSCH); a frequency hopping flag to indicate whether the UE is to transmit on the PUSCH with or without frequency; a modulation and coding scheme (MCS) field from which the UE can determine the MCS for the PUSCH transmission; and a transmit power control (TPC) command value for setting the power of the PUSCH transmission. The RAR transmission step is often referred to as message 2 (Msg2) transmission. The UE then sends a third message (message 3 or ‘Msg3’) to the network over the physical uplink shared channel (PUSCH) based on the information in the RAR. The specific message sent by the UE in this step, and the content of the message, depends on the context in which the random access procedure is being used. In the example of initial radio RRC connection setup, however, Msg3 typically comprises an RRC Setup request or similar message carrying a temporary randomly generated UE identifier. The network responds with a fourth message (message 4 or ‘Msg4’) which carries the randomly generated UE identifier received in Msg3 for contention purposes to resolve any collisions between different UEs using the same preamble sequence. When successful, Msg4 also transfers the UE to a connected state.

A similar random access procedure may also be used in other contexts within NR including, for example, handover, connection reestablishment, requesting UL scheduling where no dedicated resource for a scheduling-request has been configured for the UE, etc.

A so-called two-step random access procedure has been introduced (in addition to the above described four-step random access procedure). The two-step random access is mainly intended for supporting (Ultra) Low Latency Communications, 10 ms control plane latency, fast handover, efficient channel access in unlicensed spectrum, and transmission of small data packets, amongst others. However, it may also apply to large cells such as non-terrestrial cells. The main difference is that whilst the four-step random access procedure requires two round-trip cycles between the UE and the base station, the two-step random access procedure aims to reduce latency and control-signalling overhead by using a single round trip cycle between the UE and the base station. Effectively, this is achieved by combining the UE's PRACH preamble (Msg1) transmission and the scheduled PUSCH transmission (Msg3) into a single message (referred to as ‘MsgA’). Similarly, the random access response (RAR/Msg2) from the base station to UE and the contention resolution message (Msg4) are combined in the two-step random access procedure (and referred to as ‘MsgB’).

As those skilled in the art will appreciate, while a contention based PRACH procedure is described, a non-contention based (or ‘contention free’) procedure may also be used in which a dedicated preamble is assigned by the base station to the UE.

As communication technology has developed the maximum carrier bandwidth has grown (e.g. from 20 MHz in LTE to 400 MHz in NR). As the maximum bandwidth increases so do does the cost, in terms of power consumption, for a UE to scan the full bandwidth. Moreover, as cellular networks are required to support increasing numbers of UE types having varying capabilities, there are increasing numbers of device types that are incapable of communicating using the maximum carrier bandwidth.

This has led, in part, to the formulation of the concept of the bandwidth part (BWP) although it will be appreciated that the benefits provided by BWPs are not limited to more recent communication technology such as 5G.

As the name suggests, a BWP comprises part of a total carrier bandwidth comprising a contiguous set of physical resource blocks, selected from a contiguous subset of the common resource blocks for a given numerology (p), on a given carrier. Each BWP thus starts at a common resource block, spans over a set of consecutive common resource blocks within the carrier bandwidth and is associated with its own numerology (i.e. corresponding to a specific sub-carrier spacing, ‘SCS’, and cyclic prefix, ‘CP’). Accordingly, even a UE that has the capability to use the maximum bandwidth may be configured to use a BWP with a narrow bandwidth during periods of relatively low communication activity and a wider bandwidth when there are large amounts of data to be transferred.

For each serving cell at least one downlink (DL) BWP and, if the serving cell is configured with an uplink (UL), at least one UL BWP. Currently, a UE can be configured with up to four DL BWPs and up to four UL BWPs for each serving cell. In case of supplementary uplink (SUL), there can be up to four additional uplink BWPs on the SUL carrier.

An initial DL BWP and an initial UL BWP are configured for at least the initial access procedure before a RRC connection is established. A UE uses an initial BWP when first accessing a cell. The initial DL BWP can be signalled within SIB1. The initial DL BWP parameter structure (e.g. defined by an InitialDLBWP information element) also specifies the subcarrier spacing for the BWP and provides the UE with cell level information for receiving the physical downlink control channel (PDCCH) and physical downlink shared channel (PDSCH). If the parameter structure is not provided to a UE, then the initial DL BWP is defined by the set of Resource Blocks belonging to the CORESET #0. These Resource Blocks can be deduced from the master information block (MIB). Information regarding the initial UL BWP comprises common UL BWP configuration information (e.g. as defined by an InitialULBWP information element (IE) with information corresponding to a BWP-UplinkCommon IE). The common UL BWP configuration information (e.g., BWP-UplinkCommon IE) can be signalled within system information (e.g., SIB1) or by dedicated signalling (e.g. in an RRC setup or RRC (re)configuration message), for example as part of an uplink configuration (e.g., forming part of an uplinkConfigCommonSIB/uplinkConfigCommon IE forming part of the system information/dedicated signalling).

The common UL BWP configuration information is used to configure the common parameters (cell-specific) of an uplink BWP. As discussed above, the common parameters of the initial uplink BWP of a PCell can be provided via system information. For all other serving cells, the network provides this information via dedicated signalling. The common UL BWP configuration information includes, amongst other things, for example: common configuration parameters for the physical uplink shared channel (PUSCH), common configuration parameters for the physical uplink control channel (PUCCH), common configuration parameters for the random access channel (RACH), and common configuration parameters for transmission of MsgA in the two-step random access type procedure.

More recently, provision has been made for a UE to request repetition for Msg3 when attempting to initiate initial access (e.g., when sending Msg1), if the UE supports such Msg3 repetition. In this scenario, the RAR (Msg2) uplink grant may be used to schedule one or more initial Msg3 transmissions over one or multiple slots (i.e., repetitions). Moreover, downlink control information (DCI) may be transmitted (e.g., in a physical downlink control channel (PDCCH)) for scheduling further retransmission of Msg3 over one or multiple slots (i.e., repetition is applied to retransmission grant) retransmissions. For example, DCI using DCI format 00 with a cyclic-redundancy check (CRC) scrambled by a temporary cell radio network temporary identifier (TC-RNTI) may be used for this purpose.

To support this the network provides, as part of the common UL BWP configuration information, a configuration of one or more sets of random access resources (e.g., a set of preambles and/or one or more other parameters to be applied by the UE when performing random access) that is specifically associated with a Msg3 repetition feature indication (or a combination of feature indications including a Msg3 repetition feature indication). The network can also configure, as part of the common UL BWP configuration information, a threshold to be used by the UE for determining whether to select resources indicating Msg3 repetition in a given BWP. The network can also configure, as part of the common UL BWP configuration information, a set of modulation and coding scheme (MCS) indexes for Msg3 repetition. The network can also configure, as part of the common UL BWP configuration information, a list of possible numbers of repetitions for Msg3 repetition.

### SUMMARY OF INVENTION

### Technical Problem

Accordingly, a UE can be provided, in the UL BWP common configuration information, a set of numbers of repetitions for a Msg3 PUSCH transmission with PUSCH repetitions in each of a plurality of slots (i.e., Type A). When a UE requests repetitions for the Msg3 PUSCH transmission, the UE transmits the PUSCH in a number ‘N’ slots where N indicated by the 2 most significant bits (MSBs) of an MCS field in the RAR UL grant, or in the DCI format 00, from the set of values provided by the list of possible numbers of repetitions in the common UL BWP configuration information, or from default values if the list is not provided. The UE determines an MCS for the PUSCH transmission from the 2 least significant bits (LSBs) of the MCS field in the RAR UL grant or from the 3 LSBs of an MCS field in the DCI format 0_0.

In summary, therefore, the network can configure one or more sets of random access resources in association with a MSG3 repetition indication and a RSRP threshold.

The UE can request Msg3 repetition if the UE supports the feature, a configuration of one or more sets of random access resources in association with a MSG3 repetition indication is received, and the downlink pathloss RSRP at the UE is lower than the configured threshold.

After requesting Msg3 repetition, two bits in the RAR UL grant is effectively repurposed to indicate the number of repetitions. From the UE perspective, the UE will therefore interpret these two bits in the RAR UL grant differently if the UE has requested Msg3 repetition by choosing the corresponding random access resource pool for Msg1.

Effectively, therefore, this enables an earlier indication of the UE's capability for Msg3 repetition since legacy UEs will not choose the associated random access resources.

For convenience, this type of Msg3 repetition will be referred to herein as RSRP-based Msg3 repetition.

However, the current RSRP-based Msg3 repetition procedures have the potential to cause a number of issues that are particularly significant in the context of cells of NTNs.

For example, in NTN cells there is can be a significantly smaller RSRP difference between the cell edge and the cell centre than for a cell of a terrestrial based base station (especially where the space/air borne platform is located, at a large elevation angle, centrally over the NTN cell). In such a scenario it can, therefore, be more difficult to configure an RSRP threshold appropriately. It will be appreciated that a similar issue can arise for other RSRP based triggers such as, for example, for conditional handover (CHO) based on a measurement report. Accordingly, a solution to this issue has wider applicability than the context of NTN cells.

Moreover, the RSRP experienced at UEs can change quickly due to satellite movement. Hence, the number of UEs with an RSRP below the configured threshold will vary. This can result in a sub-optimal usage of the random access resource pool associated with the threshold (e.g., for Msg3 repetition). For example, the random resource pool for Msg3 repetition may became overloaded (e.g., where, due to the position of the space/air borne platform being at a relatively low elevation angle, the probability of a UE experiencing a below threshold RSRP in the NTN cell is higher) or underloaded (e.g., where, due to a position of the space/air borne platform being at a relatively high elevation angle, the probability of a UE experiencing a below threshold RSRP in the NTN cell is lower). This issue is compounded by the fact that the random access resource set size is only configured relatively infrequently (e.g., when cell parameters are configured based on system information or other signalling on arrival in a cell) and so cannot be readily changed to take account of movement of the NTN cell relative to the UE.

The current RSRP-based Msg3 repetition procedures are also relatively inflexible as they are limited to contention based procedures in which the UE selects the preamble to use to initiate the RACH procedure. It will be appreciated that this issue is generally applicable in all scenarios where Msg3 repetition (or corresponding uplink transmission repetition following a RACH procedure) may be used and is not limited to solely NTN scenarios.

### Solution to Problem

Accordingly, the present disclosure seeks to provide methods and associated apparatus that address or at least alleviate (at least one or more of) the above-described issues.

Although for efficiency of understanding for those of skill in the art, the disclosure will be described in detail in the context of a 3GPP system (5G networks including NTN), the principles of the disclosure can be applied to other systems as well. Although the present disclosure is motivated by NTN use cases, the example embodiments can be applied to any large cells and to support relatively low power UEs (e.g. IoT devices) in regular terrestrial cells.

Aspects of the disclosure are set out in the appended independent claims optional but beneficial features are set out in the appended dependent claims.

In one aspect there is provided a method performed by a user equipment (UE), the method comprising: receiving, from an access network node: first information for configuring at least one resource set for use when initiating a first type of random access procedure in which at least one uplink transmission scheduled during the random access procedure is repeatable, and second information for configuring at least one condition to be met for initiation of the first type of random access procedure; determining, based on whether or not the at least one condition is met, whether to initiate the first type of random access procedure or to initiate a second type of random access procedure in which the at least one uplink transmission scheduled during the random access procedure is not repeatable; and in a case where the at least one condition is met, initiating the first type of random access procedure using at least one resource selected from the at least one resource set configured by the first information; and in a case where the at least one condition is not met, initiating the second type of random access procedure using at least one other resource; wherein the second information configures a plurality of different threshold values for at least one parameter or characteristic that is obtainable at the UE, and the determining determines whether the at least one condition is met based on a comparison of at least one obtained value for the at least one parameter or characteristic with at least one of the plurality of different thresholds.

The plurality of different threshold values may include at least one distance based threshold value for a parameter or characteristic that changes with a distance of the UE from a reference position relative to a cell or beam provided by the access network node. The at least one distance based threshold value may be a threshold value for the distance of the UE from the reference point. The at least one distance based threshold value may be a threshold value for a timing advance parameter. The plurality of different threshold values may further include at least one reference signal received power (RSRP) threshold value for an RSRP that is measurable at the UE. The determining may determine whether the at least one condition is met using both the at least one RSRP threshold value and the at least one distance based threshold value. The determining may determine that the at least one condition is met when both a condition based on the at least one RSRP threshold value is met, and a condition based on the at least one distance based threshold value is met. The determining may determine that the at least one condition is met when either a condition based on the at least one RSRP threshold value is met, or a condition based on the at least one distance based threshold value is met.

The plurality of different threshold values may include a plurality of different reference signal received power (RSRP) threshold values for an RSRP that is measurable at the UE. Each of the plurality of different RSRP threshold values may be respectively associated with a different time point or time period. The method may further comprise selecting at least one RSRP threshold of the plurality of different RSRP thresholds that is associated with a time point or time period that corresponds to a measured time at the UE. The determining may determine whether the at least one condition is met based on the at least one RSRP threshold selected by the selecting.

The first information may configure a plurality of different resource sets for use when initiating the first type of random access procedure and each resource set may be respectively associated with a different distance range. In the case where the at least one condition is met, the method may further comprise identifying a resource set of the plurality of different resource sets that is associated with a distance range that includes an estimated distance of the UE from a reference position relative to a cell or beam provided by the access network node, and the initiating may initiate the first type of random access procedure using at least one resource selected from the identified resource set.

In a case where an initiated first type of random access procedure or initiated second type of random access procedure fails, and a further random access procedure is to be initiated, the method may further comprise redetermining, based on whether or not the at least one condition is still met, whether to initiate the further random access procedure as the first type of random access procedure or to initiate the further random access procedure as the second type of random access procedure. In a case where the at least one condition is met, the method may comprise initiating the further random access procedure as the first type of random access procedure using at least one resource reselected from the at least one resource set configured by the first information. In a case where the at least one condition is not met, the method may comprise initiating the further random access procedure as the second type of random access procedure using at least one other resource.

In one aspect there is provided a method performed by a user equipment (UE), the method comprising: receiving, from an access network node: first information for configuring a plurality of different resource sets for use when initiating a first type of random access procedure in which at least one uplink transmission scheduled during the random access procedure is repeatable, wherein each resource set is respectively associated with a different distance range, and second information for configuring at least one condition to be met for initiation of the first type of random access procedure; determining, based on whether or not the at least one condition is met, whether to initiate the first type of random access procedure or to initiate a second type of random access procedure in which the at least one uplink transmission scheduled during the random access procedure is not repeatable; and in a case where the at least one condition is met, identifying a resource set of the plurality of different resource sets that is associated with a distance range that includes an estimated distance of the UE from a reference position relative to a cell or beam provided by the access network node, and initiating the first type of random access procedure using at least one resource selected from the identified resource set; and in a case where the at least one condition is not met, initiating the second type of random access procedure using at least one other resource.

In one aspect there is provided a method performed by a user equipment (UE), the method comprising: receiving, from an access network node: first information for configuring at least one resource set for use when initiating a first type of random access procedure in which at least one uplink transmission scheduled during the random access procedure is repeatable, and second information for configuring at least one condition to be met for initiation of the first type of random access procedure, the second information indicating a value for a reference signal received power (RSRP) threshold; and determining, based on a comparison of a measured RSRP value with the value of the RSRP threshold indicated by the second information, whether the at least one condition is met; and in a case where the at least one condition is met, initiating the first type of random access procedure using at least one resource selected from the at least one resource set configured by the first information; and in a case where the at least one condition is not met, initiating a second type of random access procedure, in which the at least one uplink transmission scheduled during the random access procedure is not repeatable, using at least one other resource; wherein the second information indicates a value for the RSRP threshold that is higher than a maximum value of RSRP expected to be measured by any UE in a cell operated by the access network node.

In one aspect there is provided a method performed by a user equipment (UE), the method comprising: transmitting, to an access network node, information identifying a capability of the UE to support a contention-free random access procedure in which at least one uplink transmission scheduled during the contention-free random access procedure is repeatable; and receiving, from the access network node, information indicating that repetition of an uplink transmission scheduled during a contention-free random access procedure is enabled.

The information indicating that repetition of an uplink transmission scheduled during a contention-free random access procedure is enabled may comprise information for configuring a number of times the uplink transmission is to be repeated. The information for configuring a number of times the uplink transmission is to be repeated may indicate a plurality of possible repetition numbers and the method may further comprise identifying the number of times the uplink transmission is to be repeated from the plurality of possible repetition numbers. The number of times the uplink transmission is to be repeated may be identified from the plurality of possible repetition numbers based on further information received from the access network node during the contention-free random access procedure.

The information indicating that repetition of an uplink transmission scheduled during a contention-free random access procedure is enabled may be received in a system information broadcast. The information indicating that repetition of an uplink transmission scheduled during a contention-free random access procedure is enabled may be received in a dedicated message for the UE. The information indicating that repetition of an uplink transmission scheduled during a contention-free random access procedure is enabled may be received in a message for triggering the contention-free random access procedure at the UE.

In one aspect there is provided a method performed by an access network node, the method comprising: transmitting, to a user equipment (UE): first information for configuring at least one resource set for use when initiating a first type of random access procedure in which at least one uplink transmission scheduled during the random access procedure is repeatable, and second information for configuring at least one condition to be met for initiation of the first type of random access procedure, wherein the second information configures a plurality of different threshold values for at least one parameter or characteristic that is obtainable at the UE; and receiving, from the UE: in a case where the at least one condition is met, a message initiating the first type of random access procedure using at least one resource selected from the at least one resource set configured by the first information; and in a case where the at least one condition is not met, a message initiating a second type of random access procedure, in which the at least one uplink transmission scheduled during the random access procedure is not repeatable, using at least one other resource.

In one aspect there is provided a method performed by an access network node, the method comprising: transmitting, to a user equipment (UE): first information for configuring a plurality of different resource sets for use when initiating a first type of random access procedure in which at least one uplink transmission scheduled during the random access procedure is repeatable, wherein each resource set is respectively associated with a different distance range, and second information for configuring at least one condition to be met for initiation of the first type of random access procedure; and receiving, from the UE: in a case where the at least one condition is met, a message initiating the first type of random access procedure using at least one resource selected from a resource set of the plurality of different resource sets that is associated with a distance range that includes an estimated distance of the UE from a reference position relative to a cell or beam provided by the access network node; and in a case where the at least one condition is not met, a message initiating a second type of random access procedure, in which the at least one uplink transmission scheduled during the random access procedure is not repeatable, using at least one other resource.

In one aspect there is provided a method performed by an access network node, the method comprising: transmitting, to a user equipment (UE): first information for configuring at least one resource set for use when initiating a first type of random access procedure in which at least one uplink transmission scheduled during the random access procedure is repeatable, and second information for configuring at least one condition to be met for initiation of the first type of random access procedure, the second information indicating a value for a reference signal received power (RSRP) threshold, wherein the second information indicates a value for the RSRP threshold that is higher than a maximum value of RSRP expected to be measured by any UE in a cell operated by the access network node; and receiving, from the UE, a message initiating the first type of random access procedure using at least one resource selected from the at least one resource set configured by the first information.

In one aspect there is provided a method performed by an access network node, the method comprising: receiving, from a user equipment (UE), information identifying a capability of the UE to support a contention-free random access procedure in which at least one uplink transmission scheduled during the contention-free random access procedure is repeatable; and transmitting, to the UE, information indicating that repetition of an uplink transmission scheduled during a contention-free random access procedure is enabled.

In one aspect there is provided a user equipment (UE) comprising: means for receiving, from an access network node: first information for configuring at least one resource set for use when initiating a first type of random access procedure in which at least one uplink transmission scheduled during the random access procedure is repeatable, and second information for configuring at least one condition to be met for initiation of the first type of random access procedure; means for determining, based on whether or not the at least one condition is met, whether to initiate the first type of random access procedure or to initiate a second type of random access procedure in which the at least one uplink transmission scheduled during the random access procedure is not repeatable; means for initiating, in a case where the at least one condition is met, the first type of random access procedure using at least one resource selected from the at least one resource set configured by the first information; and means for initiating, in a case where the at least one condition is not met, the second type of random access procedure using at least one other resource; wherein the second information configures a plurality of different threshold values for at least one parameter or characteristic that is obtainable at the UE, and the means for determining is configured to determine whether the at least one condition is met based on a comparison of at least one obtained value for the at least one parameter or characteristic with at least one of the plurality of different thresholds.

In one aspect there is provided a user equipment (UE) comprising: means for receiving, from an access network node: first information for configuring a plurality of different resource sets for use when initiating a first type of random access procedure in which at least one uplink transmission scheduled during the random access procedure is repeatable, wherein each resource set is respectively associated with a different distance range, and second information for configuring at least one condition to be met for initiation of the first type of random access procedure; means for determining, based on whether or not the at least one condition is met, whether to initiate the first type of random access procedure or to initiate a second type of random access procedure in which the at least one uplink transmission scheduled during the random access procedure is not repeatable; means for identifying, in a case where the at least one condition is met, a resource set of the plurality of different resource sets that is associated with a distance range that includes an estimated distance of the UE from a reference position relative to a cell or beam provided by the access network node, and for initiating the first type of random access procedure using at least one resource selected from the identified resource set; and means for initiating, in a case where the at least one condition is not met, the second type of random access procedure using at least one other resource.

In one aspect there is provided a user equipment (UE) comprising: means for receiving, from an access network node: first information for configuring at least one resource set for use when initiating a first type of random access procedure in which at least one uplink transmission scheduled during the random access procedure is repeatable, and second information for configuring at least one condition to be met for initiation of the first type of random access procedure, the second information indicating a value for a reference signal received power (RSRP) threshold; and means for determining, based on a comparison of a measured RSRP value with the value of the RSRP threshold indicated by the second information, whether the at least one condition is met; means for initiating, in a case where the at least one condition is met, the first type of random access procedure using at least one resource selected from the at least one resource set configured by the first information; and means for initiating, in a case where the at least one condition is not met, a second type of random access procedure, in which the at least one uplink transmission scheduled during the random access procedure is not repeatable, using at least one other resource; wherein the second information indicates a value for the RSRP threshold that is higher than a maximum value of RSRP expected to be measured by any UE in a cell operated by the access network node.

In one aspect there is provided a user equipment (UE) comprising: means for transmitting, to an access network node, information identifying a capability of the UE to support a contention-free random access procedure in which at least one uplink transmission scheduled during the contention-free random access procedure is repeatable; and means for receiving, from the access network node, information indicating that repetition of an uplink transmission scheduled during a contention-free random access procedure is enabled.

In one aspect there is provided an access network node comprising: means for transmitting, to a user equipment (UE): first information for configuring at least one resource set for use when initiating a first type of random access procedure in which at least one uplink transmission scheduled during the random access procedure is repeatable, and second information for configuring at least one condition to be met for initiation of the first type of random access procedure, wherein the second information configures a plurality of different threshold values for at least one parameter or characteristic that is obtainable at the UE; and means for receiving, from the UE: in a case where the at least one condition is met, a message initiating the first type of random access procedure using at least one resource selected from the at least one resource set configured by the first information; and in a case where the at least one condition is not met, a message initiating a second type of random access procedure, in which the at least one uplink transmission scheduled during the random access procedure is not repeatable, using at least one other resource.

In one aspect there is provided an access network node comprising: means for transmitting, to a user equipment (UE): first information for configuring a plurality of different resource sets for use when initiating a first type of random access procedure in which at least one uplink transmission scheduled during the random access procedure is repeatable, wherein each resource set is respectively associated with a different distance range, and second information for configuring at least one condition to be met for initiation of the first type of random access procedure; and means for receiving, from the UE: in a case where the at least one condition is met, a message initiating the first type of random access procedure using at least one resource selected from a resource set of the plurality of different resource sets that is associated with a distance range that includes an estimated distance of the UE from a reference position relative to a cell or beam provided by the access network node; and in a case where the at least one condition is not met, a message initiating a second type of random access procedure in which the at least one uplink transmission scheduled during the random access procedure is not repeatable using at least one other resource.

In one aspect there is provided an access network node comprising: means for transmitting, to a user equipment (UE): first information for configuring at least one resource set for use when initiating a first type of random access procedure in which at least one uplink transmission scheduled during the random access procedure is repeatable, and second information for configuring at least one condition to be met for initiation of the first type of random access procedure, the second information indicating a value for a reference signal received power (RSRP) threshold, wherein the second information indicates a value for the RSRP threshold that is higher than a maximum value of RSRP expected to be measured by any UE in a cell operated by the access network node; and means for receiving, from the UE, a message initiating the first type of random access procedure using at least one resource selected from the at least one resource set configured by the first information.

In one aspect there is provided an access network node comprising: means for receiving, from a user equipment (UE), information identifying a capability of the UE to support a contention-free random access procedure in which at least one uplink transmission scheduled during the contention-free random access procedure is repeatable; and means for transmitting, to the UE, information indicating that repetition of an uplink transmission scheduled during a contention-free random access procedure is enabled.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) communication system to which example embodiments of the disclosure may be applied;

FIG. 2A each respectively illustrate a possible implementation of an access network that may be used in the system of FIG. 1;

FIG. 2B each respectively illustrate a possible implementation of an access network that may be used in the system of FIG. 1;

FIG. 2C each respectively illustrate a possible implementation of an access network that may be used in the system of FIG. 1;

FIG. 3 is a simplified block schematic illustrating the main components of a user equipment that may be used in the system shown in FIGS. 1, and 2A to 2C;

FIG. 4 is a simplified block schematic illustrating the main components of a base station/access network node that may be used in the system shown in FIGS. 1, and 2A to 2C;

FIG. 5 is a simplified block schematic illustrating the main components of a base station of a distributed type that may be used in the system shown in FIGS. 1, and 2A to 2C;

FIG. 6 is a simplified sequence diagram illustrating a random access procedure involving Msg3 repetition that may be used in the communication system of FIG. 1;

FIG. 7 is a simplified sequence diagram illustrating another random access procedure involving Msg3 repetition that may be used in the communication system of FIG. 1;

FIG. 8 is a simplified sequence diagram illustrating another random access procedure involving Msg3 repetition that may be used in the communication system of FIG. 1;

FIG. 9 is a simplified sequence diagram illustrating another random access procedure involving Msg3 repetition that may be used in the communication system of FIG. 1;

FIG. 10 is a simplified sequence diagram illustrating another random access procedure involving Msg3 repetition that may be used in the communication system of FIG. 1; and

FIG. 11 is a simplified sequence diagram illustrating a number of options for enabling Msg3 repetition/indicating a number of repetitions for contention free random access that may be used in the communication system of FIG. 1.

### DESCRIPTION OF EMBODIMENTS

### Overview

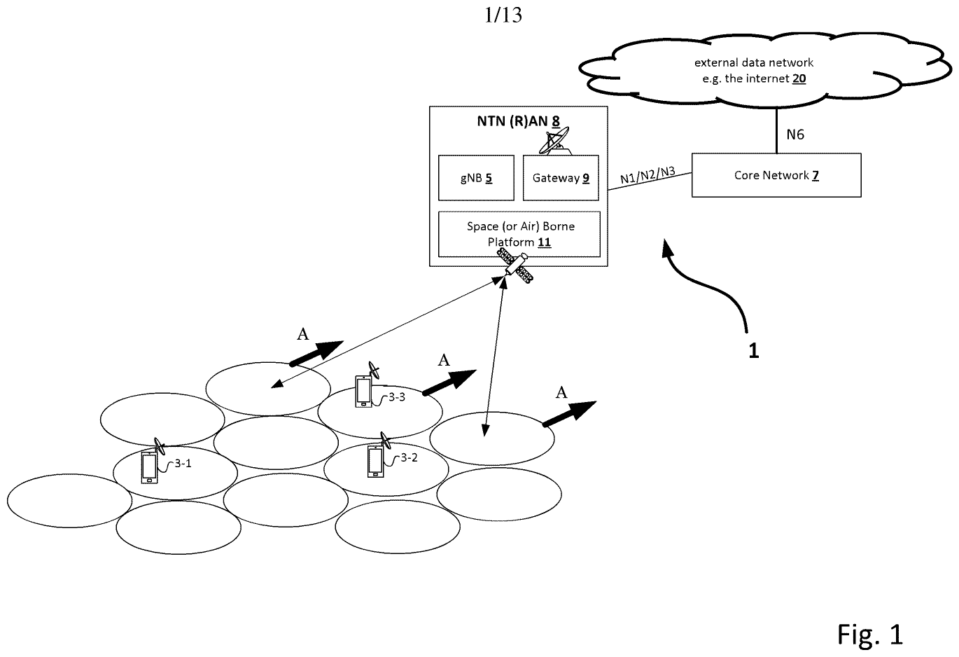

FIG. 1 illustrates schematically a mobile (cellular or wireless) communication system 1 to which example embodiments of the disclosure may be applied.

In this communication system 1, users of items of user equipment (UEs) 3-1, 3-2, 3-3 (e.g. mobile telephones and/or other mobile devices) can communicate with each other and/or other user equipment via a non-terrestrial network (NTN) radio access network (RAN) 8 that operates according to one or more compatible radio access technologies (RATs), for example, an E-UTRA (4G) and/or NR (5G) RAT. In case of an E-UTRA RAT, the base station 5 may be referred to as an ‘eNB’ or ‘ng-eNB’ and in case of an NR RAT, the base station 5 may be referred to as a ‘gNB’. In the illustrated example, the NTN RAN 8 comprises a base station 5 or ‘gNB’ operating one or more associated cells, a gateway 9, and a non-terrestrial (space or air borne) platform 11 (e.g. comprising one or more satellites and/or airborne vehicles), which may be referred to generally as a ‘satellite’ for simplicity. Communication via the NTN RAN 8 is typically routed through a core network 7 (e.g. a 5G core network or evolved packet core network (EPC)) and one or more external data networks 20 (e.g. via an N6 interface/reference point or the like).

As those skilled in the art will appreciate, whilst three UEs 3 and one NTN RAN 8 comprising one base station 5, one gateway 9 and one non-terrestrial platform 11, are shown in FIG. 1 for illustration purposes, the system, when implemented, will typically include any number of UEs, other RANs (both terrestrial and non-terrestrial), NTN platforms, base stations, gateways, UEs etc.

Although not shown in FIG. 1, neighbouring base stations 5 may be connected to each other via an appropriate base station to base station interface (such as the so-called ‘X2’ interface, ‘Xn’ interface and/or the like). The base station 5 is also connected to the core network nodes via appropriate interfaces (such as the so-called ‘N2’ and ‘N3’ interfaces in NR, and/or the like). The UEs 3 will also be connected to the core network nodes (transparently via the base station 5) using an appropriate interface (such as the so-called ‘S1’ interface, ‘N1’ interface, and/or the like).

The core network 7 (e.g. the EPC in case of LTE or the NGC in case of NR/5G) typically includes logical nodes (or ‘functions’) for supporting communication in the communication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3.

Each NTN RAN 8 controls a number of directional satellite beams via which associated NTN cells may be provided. Specifically, each satellite beam has an associated footprint on the surface of the Earth which forms an NTN cell, or part of an NTN cell. Each NTN cell has an associated Physical Cell Identity (PCI). The satellite beam footprints may be moving as the space (or air) borne platform 11 is travelling along its orbit (e.g. as illustrated by the arrows A in FIG. 1). Alternatively, the satellite beam footprint may be earth fixed, in which case an appropriate satellite beam pointing mechanism (mechanical or electronic steering) may be used to compensate for the movement of the satellite 11. Satellite beams and satellites are not considered visible from UE perspective in NTN. This does not, however, preclude differentiating at the PLMN level the type of network (e.g. NTN vs. terrestrial).

The NTN RAN 8 is configured to provide ephemeris data for the satellite 11, to the UEs 3, to help UEs 3 perform measurement and cell selection/reselection and for supporting initial access. This ephemeris data may comprise information on orbital information such as information on orbital plane level or on satellite level and/or information (e.g. a pointer or index) from which more detailed ephemeris data stored in the UE3 (e.g. in a subscriber identity module, ‘SIM’) may be obtained. At least some of this ephemeris information may, for example, be provided in system information and/or may be provided using UE specific (dedicated) signalling such as RRC signalling.

With the help of this ephemeris data, a UE 3 may search for the first NTN cell the UE 3 can connect to. After detecting an SSB of a cell broadcasted by a satellite, the UE 3 may be able to read initial system information of that cell which may contain further ephemeris information relating to the exact location of the cell (and/or to the satellite broadcasting the cell). This ephemeris information may be given relative to information relating, for example, to the orbital plane that the UE 3 may already have obtained.

The accuracy of the prediction of a satellite orbit or the satellite position can decrease with time and so, to help ensure accuracy, the ephemeris data provided to the UE 3 is updated periodically.

The same PCI may be used for several satellite beams, or there may be one PCI per satellite beam. A satellite beam can consist of one or more SSB beams with one cell (PCI) having a maximum of L SSB beams, where L can typically be 4, 8 or 64 depending on the band. During initial access, the UEs 3 perform cell search based on SSBs where each SSB is transmitted in a different respective beam. Each SSB comprises a primary synchronization signal (PSS), secondary synchronization signal (SSS), and physical broadcast channel (PBCH). As the SSB carries synchronization signals (SSs)/PBCH (SS/PBCH) transmissions it is sometimes referred to as an SS/PBCH block.

The UEs 3 and a RAN equipment (e.g. a base station 5, a gateway 9 and/or a non-terrestrial platform 11) of the communication system 1 are mutually configured for performing a random access channel (RACH) procedure for the UE 3 to access the network. Specifically, on detection and selection of a cell (and/or a beam in the case of 5G) the UE 3 is able to attempt access to that cell and/or beam using an initial radio resource control (RRC) connection setup procedure comprising a random access procedure. Prior to attempting initial access the UE 3 chooses random access resources (including, for example, a preamble) to use to initiate the RACH procedure. The UE 3 sends the selected preamble (e.g., in ‘Msg1’) to the RAN equipment over a physical random access channel (PRACH) for initiating the process to obtain synchronization in the uplink (UL). In response, the RAN equipment responds with a random access response (RAR) (or ‘Msg2’). The RAR indicates reception of the preamble and includes: a timing-alignment (TA) command for adjusting the transmission timing of the UE 3 based on the timing of the received preamble; an uplink grant field indicating the resources to be used in the uplink for a physical uplink shared channel (PUSCH); a frequency hopping flag to indicate whether the UE 3 is to transmit on the PUSCH with or without frequency; a modulation and coding scheme (MCS) field from which the UE 3 can determine the MCS for the PUSCH transmission; and a transmit power control (TPC) command value for setting the power of the PUSCH transmission. The UE 3 then sends a third message (‘Msg3’) to the network over a physical uplink shared channel (PUSCH) based on the information in the RAR. The specific message sent by the UE 3 in this step, and the content of the message, depends on the context in which the random access procedure is being used. In the example of initial radio RRC connection setup, however, Msg3 typically comprises an RRC Setup request or similar message carrying a temporary randomly generated UE identifier. The network responds with a fourth message (‘Msg4’) which carries the randomly generated UE identifier received in Msg3 for contention purposes to resolve any collisions between different UEs using the same preamble sequence. When successful, Msg4 also transfers the UE 3 to a connected state.

While a four-step contention-based RACH procedure is described it will be appreciated that a UE 3 and the RAN equipment of the communication system 1 may also perform a non-contention based (or ‘contention free’) procedure in which a dedicated preamble is assigned by the RAN equipment to the UE 3. Moreover, a UE 3 and the RAN equipment of the communication system 1 may perform a two-step RACH procedure (e.g., as described in the introduction).

It will be appreciated that while the UE 3 can trigger initiation of the RACH procedure itself (e.g., when the UE 3 needs to connect to the network), initiation of the RACH procedure may be by the network. For example, a RACH procedure may be initiated via a message sent via downlink control information (DCI) with an appropriate DCI format (e.g. 10) in a physical downlink control channel (PDCCH)—such a message id commonly known as a PDCCH order. A RACH procedure may be also initiated by the RAN equipment when handover is required (e.g., using a handover command message).

The UEs 3 and the RAN equipment of the communication system 1 are also mutually configured for operation using bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. For each serving cell of a UE 3, the RAN equipment (e.g. the base station 5) can configure at least one downlink (DL) BWP (e.g. an initial DL BWP). The RAN equipment may configure the UE 3 with up to a maximum (typically four) DL BWPs with only a single DL BWP being active at a given time.

Where the serving cell is configured with an uplink (UL), the RAN equipment can configure at least one UL BWP (e.g. an initial UL BWP). The RAN equipment may configure the UE 3 with up to a maximum (typically four) UL BWPs with only one UL BWP being active at a given time. The communication system 1 of this example also supports a supplementary UL (SUL), on which an additional set of one or more UL BWPs can also be configured (e.g. up to a maximum of four SUL BWPs) as for the ‘normal’ UL carrier. This provides for potentially twice as many UL BWPs (typically a maximum of eight UL BWPs).

Specifically, the RAN equipment is able to provide common DL BWP configuration information to the UE 3 to configure an initial DL BWP (e.g. by means of an initialDownlinkBWP IE/BWP-DownlinkCommon IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information (e.g. in a ServingCellConfigCommonSIB IE in SIB1) or may be provided via dedicated signalling (e.g. in a ServingCellConfigCommon IE within an RRC message).

The RAN equipment is also able to provide common UL BWP configuration information to the UE 3 to configure an initial UL BWP (e.g. by means of an initialUplinkBWP IE/BWP-UplinkCommon IE) via system information (SIB1) and/or via dedicated (e.g. RRC) signalling (e.g. an RRC reconfiguration, RRC resume, or RRC setup message). For example, the common parameters for the initial UL BWP may be provided via system information (e.g., in a ServingCellConfigCommonSIB IE in SIB1), or may be provided via dedicated signalling (e.g. in a ServingCellConfigCommon IE within an RRC message). Where an SUL is configured, an additional initial BWP may be configured.

For example, the common parameters of the initial uplink BWP of a PCell can be provided via system information. For all other serving cells, the base station 5 can provide this information via dedicated signalling. The common UL BWP configuration information includes, amongst other things, for example: common configuration parameters for the physical uplink shared channel (PUSCH), common configuration parameters for the physical uplink control channel (PUCCH), common configuration parameters for the random access channel (RACH), and common configuration parameters for transmission of MsgA in the two-step random access type procedure.

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a physical downlink control channel (PDCCH) for scheduling system information blocks.

After receiving the system information (e.g. SIB1) a UE 3 can use the BWP configuration defined by that system information to configure the initial DL BWP and initial UL BWP. The configured initial UL BWP can thus be used to initiate the random access procedure for setting up an RRC connection. The RAN 8 configures the frequency domain location and bandwidth of the initial DL BWP in the SIB1 so that the initial DL BWP contains the entire CORESET #0 in the frequency domain.

The UEs 3 and the RAN equipment of the communication system 1 are also mutually configured to support a request by the UE 3 for Msg3 repetition when attempting to initiate initial access (e.g., when sending Msg1 of a RACH procedure). Specifically, the RAN equipment is able to provide as part of the common UL BWP configuration information, a configuration of one or more sets of random access resources (e.g., a set of preambles and/or one or more other parameters to be applied by the UE when performing random access) that is specifically associated with a Msg3 repetition feature indication (or a combination of feature indications including a Msg3 repetition feature indication). This can, for example, be provided as a list of feature or feature combination-specific RACH configurations (e.g., in an AdditionalRACH-ConfigList IE). Each RACH configuration may be defined by a further set of common RACH configuration parameters in addition to the one configured by the main common configuration parameters for the RACH and/or by the main common configuration parameters for transmission of MsgA. The network can associate all possible preambles of such an additional RACH configuration to a feature or feature combination (including the Msg3 repetition feature).

The RAN equipment can also configure, as part of the common UL BWP configuration information, a threshold to be used by the UE for determining whether to select resources indicating Msg3 repetition in a given BWP (e.g., using a rsrp-ThresholdMsg3). The threshold may, for example, be a reference signal received power (RSRP) threshold below which an associated measured/estimated downlink parameter (e.g., an RSRP of a downlink pathloss reference value) at the UE must be for Msg3 repetition to be applicable for a random access procedure.

The RAN equipment can also configure, as part of the common UL BWP configuration information (e.g., using a mcs-Msg3-Repetitions IE), a set of eight modulation and coding scheme (MCS) indexes for Msg3 repetition (i.e., PUSCH transmission scheduled by the RAR UL grant and (re)transmission scheduled by DCI format 0_0 with CRC scrambled by TC-RNTI). If this field is absent when one or more sets of random access resources associated with a MSG3 repetition feature indication are configured in the common UL BWP information, the UE applies default values (e.g., {0, 1, 2, 3, 4, 5, 6, 7}). Only the first four of the candidate MCS indexes are used for used for PUSCH transmission scheduled by the RAR UL grant.

The RAN equipment can also configure, as part of the common UL BWP configuration information, (e.g., using a numberOfMsg3-RepetitionsList IE) a list of possible numbers of repetitions for Msg3 repetition (i.e., PUSCH transmission scheduled by RAR UL grant and (re)transmission scheduled by DCI format 0_0 with CRC scrambled by TC-RNTI). If this field is absent when one or more sets of random access resources associated with a MSG3 repetition feature indication are configured in the common UL BWP information, the UE 3 applies default values (e.g., {n1, n2, n3, n4}).

Accordingly, the UE 3 can be provided, in the UL BWP common configuration information, a set of numbers of repetitions for a Msg3 PUSCH transmission with PUSCH repetitions in each of a plurality of slots (i.e., Type A) that is scheduled by a RAR UL grant or by a DCI format 0_0 with CRC scrambled by a TC-RNTI. When the UE 3 requests repetitions for the Msg3 PUSCH transmission, the UE 3 transmits the Msg3 on the PUSCH in a number ‘N’ slots where N indicated by the 2 most significant bits (MSBs) of an MCS field in the RAR UL grant, or in the DCI format 0_0, from the set of four values provided by list of possible numbers of repetitions in the common UL BWP configuration information, or from the default values (e.g., {n1, n2, n3, n4}) if the list is not provided. The UE 3 determines an MCS for the PUSCH transmission from the 2 least significant bits (LSBs) of the MCS field in the RAR UL grant or from the 3 LSBs of an MCS field in the DCI format 0_0.

When a UE 3 that supports Msg3 repetition needs to initiate a random access procedure, therefore, a media access control (MAC) entity of the UE 3 can assume Msg3 repetition is applicable for the current random access procedure:
if a BWP selected for the random access procedure is configured with both one or more sets of random access resources in association with a MSG3 repetition feature indication, and one or more sets of random access resources without MSG3 repetition feature indication association, and the RSRP of a downlink pathloss reference is less than the configured threshold value; or
if the BWP selected for the random access procedure is only configured with one or more sets of random access resources in association with a MSG3 repetition feature indication.

Otherwise the UE 3 can assume the Msg3 repetition is not applicable for the current random access procedure.

Beneficially, the UEs 3 and the RAN equipment of the communication system 1 are mutually configured to implement one or more enhancements for RSRP based Msg3 repetition. It will be appreciated that while a number of different options for enhancement are described these options are neither mutually exclusive from one another nor mutually reliant on one another. More specifically, any of the described enhancements may be implemented in the UE 3/RAN equipment separately from, or in combination with, any of the other enhancements.

Beneficially, as described in more detail later, in addition to (or instead of) the RSRP threshold for Msg3 repetition, the RAN equipment broadcasts a distance/timing advance (TA) threshold. When determining whether Msg3 repetition is applicable, the UE 3 can determine that it is allowed to select a random access resource set indicated for a Msg3 repetition request when the distance to a reference position/cell centre which may be time-fixed or may vary with time (e.g., as a result of movement of a space/airborne platform) is greater than the configured distance threshold (e.g., when a TA for the UE 3 is greater than the configured TA threshold. It will be appreciated that the reference position, even if time varying, may be at a fixed location relative to the RAN equipment and/or a cell or beam provided by the RAN equipment. The UE 3 may use the distance/TA threshold instead of the RSRP threshold (e.g., effectively ignoring the RSRP threshold). Alternatively, the UE 3 may use the distance/TA threshold in combination with the RSRP threshold, for example determining that Msg3 repetition is applicable when either the RSRP experienced at the UE 3 is lower than (or no greater than) the RSRP, or the distance to the reference position/cell centre (or TA value) is less than (or no greater than) the distance threshold (or TA threshold).

Beneficially the RAN equipment alternatively, or additionally, increases the RSRP threshold sufficiently to ensure that, regardless of the RSRP seen at the UE 3, any UE 3 that supports RSRP based Msg3 repetition (or at least a significant majority of such UEs) will select random access resources from the resource pool associated with the RSRP based Msg3 repetition feature indication. The RAN equipment can assume that there is a static (stable) ratio between the number of UEs that support the Msg3 repetition feature and the number of UEs that do not support the Msg3 repetition feature. The RAN equipment can thus respectively determine an appropriate random access resource pool size for the number of UEs that support the Msg3 repetition feature and the number of UEs that do not support the Msg3 repetition feature. In a variation on this the UE 3 may be configured to simply ignore the RSRP threshold for one or more specific cell types including, for example, NTN cells.

Beneficially the RAN equipment alternatively, or additionally, configures the UE 3 with a plurality of random access resource sets for RSRP based Msg3 repetition, where each random access resource set is associated with a different respective distance range (e.g., defined by a minimum distance (mindistance) and a maximum distance (maxdistance)). When requesting Msg3 repetition, therefor, the UE 3 can select appropriate random access resources for the distance that the UE 3 is from a reference position/cell centre. This approach provides the added advantage that it effectively allows the RAN equipment to determine a coarse location for the UE 3, and then to estimate the UE's initial TA, initial signal to noise ratio (SINR), the initial Msg3 repetition times, or the like. Considering NTN is unlikely to support other features requesting RACH resource partitioning, this would also allow partition of the random access resource pool further for UEs in different locations/areas (represented by their distance from the reference position/cell centre).

Beneficially the RAN equipment alternatively, or additionally, configures the UE 3 with a list of RSRP thresholds to be used at different time by the UE 3. For example, the RAN equipment may configure a list of RSRP thresholds in association with respective time windows [t1-t2] for each RSRP threshold. The UE 3 then uses the RSRP threshold corresponding to current time measured at the UE 3. In a variation on this, the RAN equipment may configure a list of RSRP thresholds in association with respective time, Tx, for each RSRP threshold. The UE 3 can then either use the RSRP threshold with the corresponding time Tx that is closest to a current time measured at UE 3. It will be appreciated that, rather than use the RSRP threshold for time Tx, the UE 3 can use a calculated RSRP threshold for the current measured time using linear function based on Tx, the corresponding RSRP threshold, and the current time.

Beneficially, in the event that the random access attempt fails (e.g., at a contention resolution step), the UE 3 re-selects the random access resource set/pool to use (e.g., for requesting Msg3 repetition if Msg3 repetition remains applicable or for a RACH procedure without Msg3 repetition if Msg3 repetition is no longer applicable) based on the current situation prevailing at the UE 3 (e.g., the current RSRP verses a corresponding RSRP threshold and/or the current distance/TA verses a corresponding distance/TA threshold). This approach can be particularly advantageous in an NTN scenario (especially earth moving cell scenario) where there may be a long delay between a first msg1 transmission and a second msg1 transmission. With the possibility of fast satellite motion, the UE's RSRP/distance/TA situation may change significantly, and so it is beneficial to repeat the check of whether Msg3 repetition is applicable or not based on the situation prevailing when the second msg1 transmission needs to take place.

Beneficially, the UEs 3 and the RAN equipment of the communication system 1 are also (alternatively or additionally) mutually configured to implement one or more enhancements for implementing RSRP based ‘Msg3’ repetition for a contention-free RACH procedure. Here it will be appreciated that for a contention free random access procedure, the procedure is effectively complete following successful receipt, by the UE 3, of the corresponding RAR (matched Msg2). Nevertheless, there is an UL grant in the RAR for a subsequent PUSCH transmission. Accordingly, whilst this subsequent uplink transmission may correspond to Msg3 transmission in a contention-based procedure it may, in practice, not be referred to as a Msg3 transmission. Instead, the uplink transmission may be called the first uplink transmission after contention free random access procedure (or something similar). Hence, while reference to ‘Msg3’ repetition may be used herein for simplicity, such references in the context of a contention-free procedure should be understood to refer to the first uplink transmission following a contention-free random access procedure.

To support RSRP based ‘Msg3’ repetition (i.e., repetition of the first uplink transmission following the random access procedure) for such contention-free procedures, a UE 3 is able to indicate, to the RAN equipment, the UE's capability to support the ‘Msg3’ repetition feature (or, more specifically, the UE's capability to support the ‘Msg3’ repetition feature in the context of a contention-free random access procedure). For a UE 3 that supports the ‘Msg3’ repetition feature (in the context of a contention-free random access procedure), the RAN equipment will enable ‘Msg3’ repetition for contention-free random access procedures and will inform the UE 3 of the number of repetition times for the ‘Msg3’ repetition. As will be described in more detail later, there are a number of different ways in which the number of repetition times for the ‘Msg3’ repetition can be informed to the UE 3 in the context of a contention-free random access procedure.

As those skilled in the art will understand, while the disclosure is described in the context of an NTN based RAN/base station, the technical features described are generally applicable to, and can be implemented in any RAN/base station of a more conventional (non-NTN) based communication system.

It will be appreciated that, while the description focusses on UL grant in the RAR, for contention based case as long as it is determined that msg3 repetition is applicable based on configuration/threshold, msg3 repetition could be applied to not only RAR UL grant but also grant indicated by DCI format0-0 (which is retransmission grant after gNB fails decode msg3 from all previous transmissions and repetitions).

Various apparatus that may be used for implementing the communication system 1 will now be described, by way of example only.

### NTN RAN

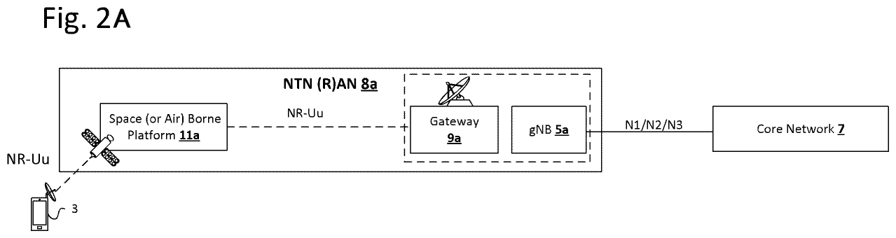

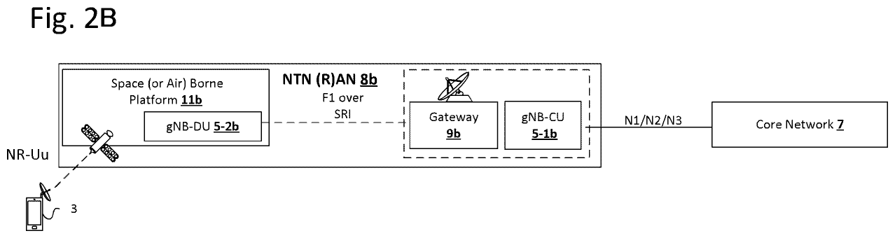

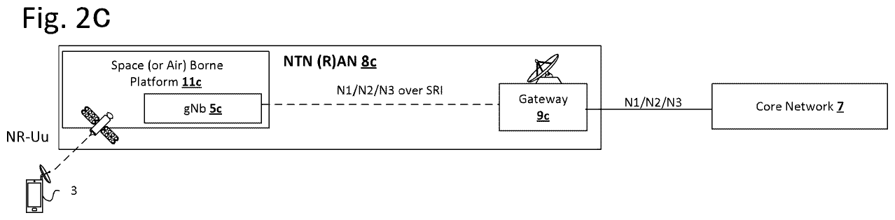

FIGS. 2A to 2C each respectively illustrate a possible implementation of an access network 8 that may be used in the system of FIG. 1. As seen in FIGS. 2A to 2C the NTN RAN 8 may be implemented in a number of different ways.

For example, as seen in FIG. 2A, the base station 5 may comprise a terrestrially located base station 5a that sends and receives communications respectively destined for and originating from the UEs 3 via a terrestrially located gateway 9a and via a non-terrestrial platform 11a that has no base station functionality. The non-terrestrial platform 11a relays these communications to and from the UEs 3 in one or more cells operated by the base station 5a, and from and to the gateway 9a as required. The non-terrestrial platform 11a relays these communications transparently without on-board processing them in effect acting as a so-called ‘bent-pipe’. In this implementation, the feeder link between the gateway 9a and the non-terrestrial platform 11a effectively acts as part of the NR-Uu interface (or reference point) between the base station 5a and one or more UEs 3. Similarly, the service link between the non-terrestrial platform 11a and one or more UEs 3 effectively acts as another part of the NR-Uu interface (or reference point) between the base station 5a and one or more UEs 3. The base station's communication link with the core network 7 (e.g. for signalling over the N1, N2, N3 interface/reference point etc.) is provided solely terrestrially.

As seen in FIG. 2B the base station 5 may, for example, comprise a base station 5b of a distributed type having a terrestrially located central unit (CU) 5-1b and a distributed unit (DU) 5-2b provided on-board the non-terrestrial platform 11b. The terrestrially located CU 5-1b performs some of the (typically higher layer) functionality of the base station 5b whereas the non-terrestrially located DU 5-2b performs other (typically lower layer) functionality of the base station 5b. The terrestrially located CU 5-1b communicates with the non-terrestrially located DU 5-2b via the gateway 9b and an F1 interface implemented via a satellite radio interface between the gateway 9b and the non-terrestrial platform 11b in which the DU 5-2b is provided.

The non-terrestrial platform 11b transmits communications destined for and originating from the UEs (3) in one or more cells operated by the base station 5b, and from and to the gateway 9a as required. However, in this implementation lower layer processing of communication respectively destined for and originating from the UEs (3) is performed on-board the non-terrestrial platform 11b by the DU 5-2b and higher layer processing of that communication respectively destined for and originating from the UEs (3) is performed by the terrestrially located CU 5-1b.

Accordingly, in this implementation, the feeder link between the gateway 9b and the non-terrestrial platform 11b effectively acts as the F1 interface (or reference point) between the CU and DU of the base station 5b. The service link between the non-terrestrial platform 11b and one or more UEs 3, on the other hand, effectively acts as the NR-Uu interface (or reference point) between the base station 5b and one or more UEs 3. The base station's communication link with the core network 7 (e.g. for signalling over the N1, N2, N3 interface/reference point etc.) is provided solely terrestrially.

As seen in FIG. 2C the base station 5 may, for example, comprise a base station 5c provided on-board the non-terrestrial platform 11c. The base station 5c on board the non-terrestrial platform 11c transmits communications destined for and originating from one or more UEs 3 in one or more cells operated by the base station 5c, and from and to the core network 7 via the gateway 9c as required. However, in this implementation, processing of communication respectively destined for and originating from one or more UEs 3 is performed on-board the non-terrestrial platform 11c by the base station 5c.

Accordingly, in this implementation, the feeder link between the gateway 9c and the non-terrestrial platform 11b effectively acts as part of the N1/N2/N3 interfaces (or reference points) between the base station 5c and the core network 7. The base station's communication link with the core network 7 (e.g. for signalling over the N1, N2, N3 interface/reference point etc.) is thus provided partly via the feeder link and partly terrestrially. The service link between the non-terrestrial platform 11c and one or more UEs 3, on the other hand, effectively acts as the NR-Uu interface (or reference point) between the base station 5c and one or more UEs 3.

The base station 5 thus controls one or more associated cells via the non-terrestrial platform 11. It will be appreciated that the base station 5 may be configured to support both 4G and 5G, and/or any other 3GPP or non-3GPP communication protocols.

### User Equipment

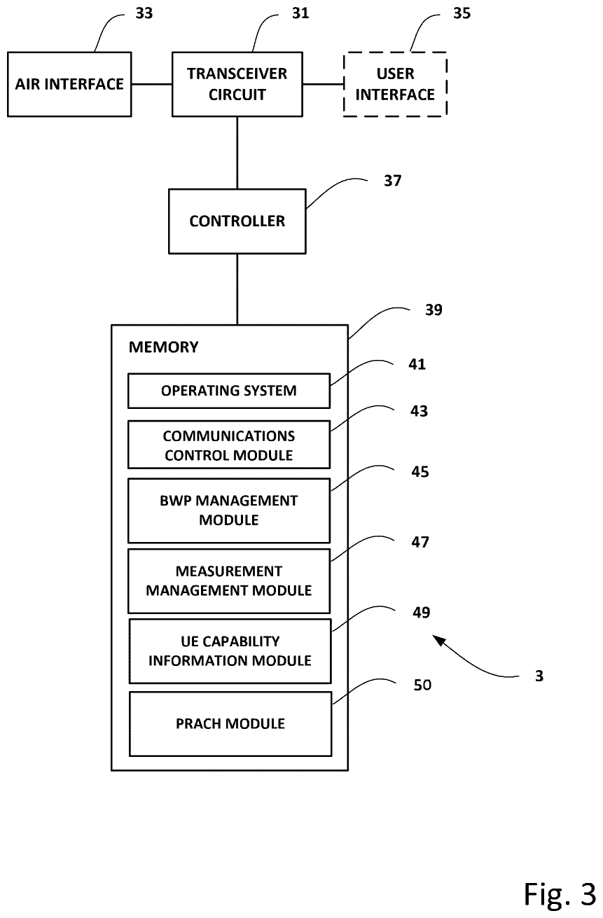

FIG. 3 is a simplified block schematic illustrating the main components of a UE 3 for implementation in the system of FIG. 1.

As shown, the UE 3 comprises transceiver circuitry 31 that is operable to transmit signals to and to receive signals from a base station 5 via an air interface 33 and one or more antennas (e.g. indirectly via a non-terrestrial platform 11 and possibly gateway 9 where applicable or directly in a wholly terrestrial scenario).

The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate.

The controller 37 is configured to control overall operation of the UE 3 by, in this example, program instructions or software instructions stored within the memory 39. The software may be pre-installed in the memory 39 and/or may be downloaded via the telecommunications network or from a removable data storage device (RMD), for example. As shown, these software instructions include, among other things, an operating system 41, a communications control module 43, a BWP management module 45, a measurement management module 47, a UE capability information module 49, and a PRACH module 50.

The communications control module 43 is operable to control the communication between the UE 3 and the base station 5. For example, the communications control module 43 controls the part played by the UE 3 in the flow of uplink and downlink user traffic and of control data to be transmitted from the base station 5 including, for example, control data for managing operation of the UE 3. The communication control module 43 is responsible, for example, for controlling the part played by the UE 3 in procedures such as the reception of measurement control/configuration information, reception of system information, RRC signalling, mobility procedures, implementing appropriate timing advances to compensate for timing misalignments etc.

The BWP management module 45 manages the performance of BWP related procedures such as: BWP configuration at the UE 3; BWP switching (including autonomous timer based or measurement triggered BWP switching); keeping track of the BWP inactivity timer; maintaining the set of initial/default BWPs configured by the base station; mapping the set of BWPs to the current UE GNSS location as the UE 3 effectively traverses the SSB beams provided by the NTN RAN 8 as a result of satellite to Earth relative movement; associated identification of the next BWP in the set of BWPs (e.g. based on the mapping and ephemeris data for the satellite provided by the base station 5) etc.

The measurement management module 47 manages the performance of measurement related procedures such as: configuration of measurements performed by the UE 3 and/or related reporting event triggers in accordance with a measurement configuration provided by the base station 5; performance of configured L1 filtered and other measurements (e.g. RSRP, RSRQ etc.); detection of measurement reporting triggering events; the sending of measurement reports; etc.

The UE capability information module 49 maintains the UE capability information comprising indications of UE capability such as, for example, the UE capability to support Msg3 repetition (and/and Msg3 repetition specifically in the context of contention-free RACH procedures) or the like. The UE capability information module 49 can provide the UE capability information to the base station 5 when appropriate (e.g. in response to a UE capability enquiry and/or automatically in response to some other event at the UE).

The PRACH module 50 manages the performance of PRACH procedures such as the contention-based or contention free random access procedures at the UE side. This includes, for example: identifying available PRACH configurations from received system information; identifying appropriate preambles and/or cyclic shifts to use for RA procedures; the reception of signalling assigning a PRACH preamble to a UE (for contention free procedures); the transmission of random access messages to the base station (e.g. Msg1 or MsgA carrying the preamble and/or Msg3); repetitions (where appropriate) of Msg3; the processing and reception of random access messages from the base station (e.g. random access response messages (Msg2, Msg4, and/or MsgB); and/or the reception and transmission of any other PRACH related signalling.

### Base Station (Non-Distributed Type)

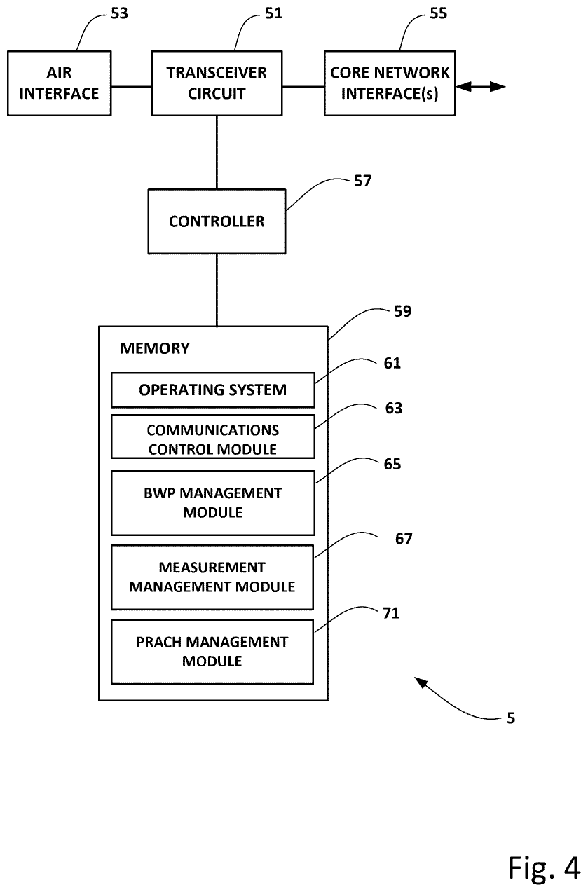

FIG. 4 is a simplified block schematic illustrating the main components of a base station 5 comprising a non-distributed type of base station for implementation in the system of FIG. 1 (e.g. in an NTN access network 8 such as RAN 8a in FIG. 2A or RAN 8c in FIG. 2C or in a wholly terrestrial RAN).

As shown, the base station 5 comprises transceiver circuitry 51 that is operable to transmit signals to and to receive signals from UEs 3 via an air interface 53 and one or more antennas (e.g. of the gateway 9 or non-terrestrial platform 11). The transceiver circuitry 51 is also operable to transmit signals to and to receive signals from functions of the core network 7 and/or other base stations 5 via a network interface 55. The network interface typically includes an N1, N2 and/or N3 interfaces for communicating with the core network and a base station to base station (e.g. Xn) interface for communicating with other base stations.

The base station 5 also comprises a controller 57 which controls the operation of the transceiver circuitry 51 in accordance with software stored in memory 59. The software may be pre-installed in the memory 59 and/or may be downloaded via the communications network 1 or from a removable data storage device (RMD), for example. The software includes, among other things, an operating system 61 a communications control module 63, a BWP management module 65, a measurement management module 67, and a PRACH management module 71.

The communications control module 63 is operable to control the communication between the base station 5 and the UEs 3 and between the base station 5 and other network entities that are connected to the base station 5. For example, the communications control module 63 controls the part played by the base station 5 in the flow of uplink and downlink user traffic and of control data to be transmitted to one or more UEs 3 served by the base station 5 including, for example, control data for managing operation of the UEs 3. The communication control module 63 is responsible, for example, for controlling the part played by the base station in procedures such as the communication of measurement control/configuration information, the broadcast of system information, RRC signalling, mobility procedures, determining and signalling appropriate timing advances to compensate for timing misalignments etc. It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The BWP management module 65 manages the performance of BWP related procedures such as: providing information to the UE 3 (e.g. via system information or dedicated signalling) for BWP configuration at the UE 3; keeping track of the BWP inactivity timer at the base station; configuring and maintaining the set of initial/default BWPs configured for the UEs served by the NTN RAN 8 of which the base station 5 is a part; mapping the set of BWPs to the current UE locations as the UEs 3 effectively traverse the SSB beams provided by the NTN RAN 8 as a result of satellite to Earth relative movement; associated identification of the next BWP in the set of BWPs for each UE 3 (e.g. based on the mapping and ephemeris data for the satellite) etc.

The measurement management module 67 manages the performance of measurement related procedures such as: provision of measurement configuration information to the UE 3 for the configuration of measurements performed by the UE 3 and/or related reporting event triggers; the receipt and interpretation of measurement reports; interpretation of L1 filtered and other measurement results (e.g. RSRP, RSRQ etc.) provided by the UE 3 in measurement reports; etc.

The PRACH management module 71 manages the configuration of the various different PRACH configurations for different types of UEs and for generating the corresponding configuration information for configuring those PRACH configurations (e.g. for provision in system information communicated under the overall control of the communication control module 63). The PRACH management module 71 also manages the performance of PRACH procedures such as the contention-based or contention free random access procedures at the base station side. This includes, for example: configuring random access resource pools/sets for the UE including resource sets associated specifically with Msg3 repetition (for contention based procedures); the assignment and signalling of a specific PRACH preamble to be used by a UE (for contention free procedures); the reception and processing of random access messages from the UE (e.g. Msg1 or MsgA carrying the preamble and/or Msg3); the transmission of random access messages to the UE (e.g. random access response messages (Msg2, Msg4, and/or MsgB); and/or for managing the reception and transmission of any other PRACH related signalling (e.g., reception of Msg3 and, where appropriate Msg3 repetitions).

### Base Station (Distributed Type)

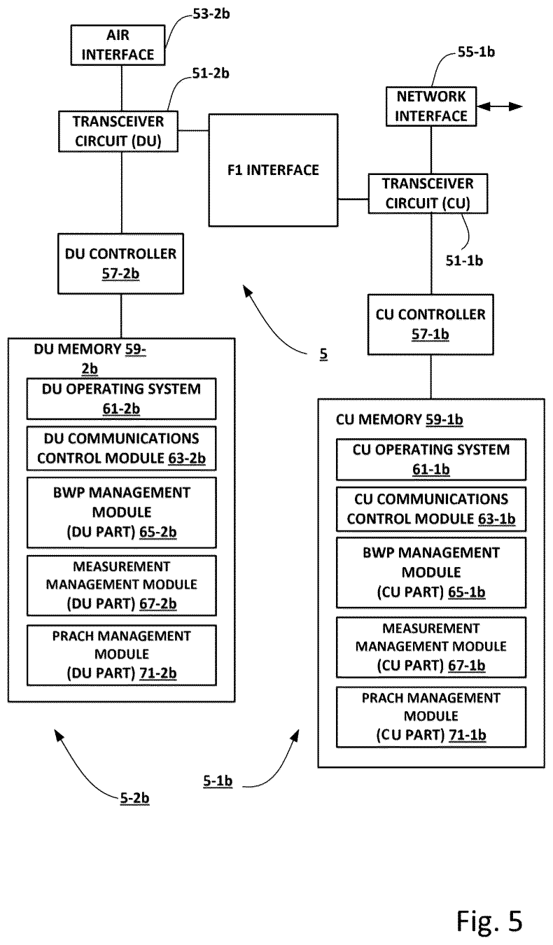

FIG. 5 is a simplified block schematic illustrating the main components of a base station 5 comprising a distributed type of base station for implementation in the system of FIG. 1 (e.g. in an NTN access network 8 such as RAN 8b in FIG. 2b or in a wholly terrestrial RAN).

As shown, the base station 5 includes a distributed unit 5-1b and a central unit 5-2b. Each unit 5-1b, 5-2b includes respective transceiver circuitry 51-1b, 51-2b. The distributed unit 5-2b transceiver circuitry 51-2b is operable to transmit signals to and to receive signals from UEs 3 via an air interface 53-2b and one or more antennas (e.g. of the non-terrestrial platform 11 where the distributed unit of the base station 5-2b is onboard such a platform 11) and is also operable to transmit signals to and to receive signals from the central unit 5-1b via an interface, for example the distributed unit side of an F1 interface (which may be provided over a satellite radio interface).

The central unit 5-1b transceiver circuitry 51-1b is operable to transmit signals to and to receive signals from functions of the core network 7 and/or other base stations 5 via a network interface 55-1b. The network interface typically includes an N1, N2 and/or N3 interfaces for communicating with the core network and a base station to base station (e.g. Xn) interface for communicating with other base stations. The central unit 5-1b transceiver circuitry 51-1b is also operable to transmit signals to and to receive signals from one or more distributed units 5-2b, for example the central unit side of the F1 interface provided, via the gateway 9b, over a satellite (or airborne platform) radio interface.

Each unit 5-1b, 5-2b includes a respective controller 57-1b, 57-2b which controls the operation of the corresponding transceiver circuitry 51-1b, 51-2b in accordance with software stored in the respective memories 59-1b and 59-2b of the distributed unit 5-2b and the central unit 5-1b. The software of each unit may be pre-installed in the memory 59-1b, 59-2b and/or may be downloaded via the communications network 1 or from a removable data storage device (RMD), for example. The software of each unit includes, among other things, a respective operating system 61-1b, 61-2b, a respective communications control module 63-1b, 63-2b, a respective BWP management module 65-1b, 65-2b, a respective measurement management module 67-1b, 67-2b, and a respective PRACH management module 71-1b, 71-2b. It will be appreciated that while the CU 5-1b and the DU 5-2b are each described as having corresponding units this may not be the case. For example, depending on the specific functionalities distributed between the CU 5-1b and the DU 5-2b any of these modules may only be present on one of the CU 5-1b and the DU 5-2b if the other unit does not contribute to that module's functions.

Each communications control module 63-1b, 63-2b is operable to control the communication of its corresponding unit 5-1b, 5-2b including the communication from one unit to the other. The communications control module 63-2b of the distributed unit 5-2b controls communication between the distributed unit 5-2b and the UEs 3, and the communications control module 63-1b of the central unit 5-1b controls communication between the central unit 5-1b and other network entities that are connected to the distributed type of base station 5b.

The communications control modules 63-1b, 63-2b also respectively control the part played by the distributed unit 5-2b and central unit 5-1b in the flow of uplink and downlink user traffic and control data to be transmitted to the communications devices served by the base station 5b including, for example, control data for managing operation of the UEs 3. Each communication control module 63-1b, 63-2b is responsible, for example, for controlling the respective part played by the distributed unit 5-2a and central unit 5-2b in procedures such as the communication of measurement control/configuration information, the broadcast of system information, RRC signalling, mobility procedures, determining and signalling appropriate timing advances to compensate for timing misalignments etc. It will be appreciated that the communications control modules 63-1b, 63-2b may also include a number of sub-modules (or ‘layers’) to support specific functionalities for the corresponding unit 5-1b, 5-2b. The modules included will depend on how the corresponding unit 5-1b, 5-2b is configured (e.g., the precise CU-DU split). For example, the communications control modules 63-1b of the distributed unit 5-2b may include a PHY sub-module, a MAC sub-module, and an RLC sub-module, whereas the communications control modules 63-1b of the central unit 5-1b may include a PDCP sub-module, an SDAP sub-module, an IP sub-module, an RRC sub-module, etc.

The BWP management modules 65-1b, 65-2b respectively manage the part played by the distributed unit 5-2b and central unit 5-1b in the performance of BWP related procedures such as: providing information to the UE 3 (e.g. via system information or dedicated signalling) for BWP configuration at the UE 3; keeping track of the BWP inactivity timer at the base station; configuring and maintaining the set of initial/default BWPs configured for the UEs served by the NTN RAN 8 of which the base station 5 is a part; mapping the set of BWPs to the current UE locations as the UEs 3 effectively traverse the SSB beams provided by the NTN RAN 8 as a result of satellite to Earth relative movement; associated identification of the next BWP in the set of BWPs for each UE 3 (e.g. based on the mapping and ephemeris data for the satellite) etc.

The measurement management modules 67-1b, 67-2b respectively manage the part played by the distributed unit 5-2b and central unit 5-1b in the performance of measurement related procedures such as: provision of measurement configuration information to the UE 3 for the configuration of measurements performed by the UE 3 and/or related reporting event triggers; the receipt and interpretation of measurement reports; interpretation of L1 filtered and other measurement results (e.g. RSRP, RSRQ etc.) provided by the UE 3 in measurement reports; etc.

The PRACH management modules 71-Tb, 71-2b respectively manage the part played by the distributed unit 5-2b and central unit 5-1b in the configuration of the various different PRACH configurations for different types of UEs and for generating the corresponding configuration information for configuring those PRACH configurations (e.g. for provision in system information communicated under the overall control of the communication control module 63). The PRACH management modules 71-1b, 71-2b also respectively manage the part played by the distributed unit 5-2b and central unit 5-1b in the performance of PRACH procedures such as the contention-based or contention free random access procedures at the base station side. This includes, for example: configuring random access resource pools/sets for the UE including resource sets associated specifically with Msg3 repetition (for contention based procedures); the assignment and signalling of a specific PRACH preamble to be used by a UE (for contention free procedures); the reception and processing of random access messages from the UE (e.g. Msg1 or MsgA carrying the preamble and/or Msg3); the transmission of random access messages to the UE (e.g. random access response messages (Msg2, Msg4, and/or MsgB); and/or for managing the reception and transmission of any other PRACH related signalling (e.g., reception of Msg3 and, where appropriate Msg3 repetitions).

When the access network node comprises a distributed base station, as shown in FIG. 5, an F1 interface (F1-C for the control plane and F1-U for the user plane) may be used to communicate signals between respective functions of the distributed base station. The software of the central unit 5-1b may include at least one of: a control plane (gNB-CU-CP) module and a user plane (gNB-CU-UP) module that can communicate with one another (e.g., via an E1 interface). If present, the gNB-CU-CP module may host the RRC layer and control plane part of the PDCP layer of the distributed base station. If present, the gNB-CU-UP module may host the user plane part of the PDCP and the SDAP layers of the distributed base station or the user plane part of the PDCP layer of the distributed base station. The software of the distributed unit 5-2b may include a gNB-DU module. If present, the gNB-DU module may host the RLC, MAC, and PHY layers of the distributed base station.

It will be understood by a person skilled in the art that central unit 5-1b may be implemented and physically located with the base station or may be implemented at a remote location, as a single physical element or as a cloud-based or virtualised system. It will also be understood that a single central unit may serve multiple base stations 5.

Various methods that may be used in the communication system 1 will now be described, by way of example only.

### Random Access Procedure for Msg3 Repetition

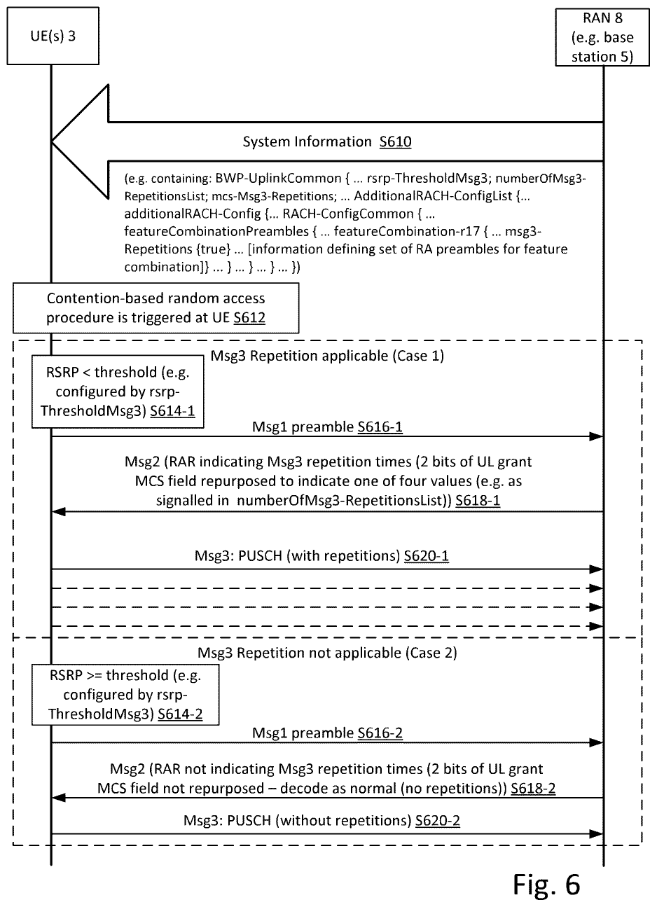

A general random access procedure involving possible RSRP based Msg3 repetition will now be described, by way of example only, with reference to FIG. 6, which is a simplified sequence diagram illustrating a random access procedure involving possible Msg3 repetition that may be used in the communication system 1.

As seen in FIG. 6 the RAN 8 is able to configure the UE 3 with appropriate information for performing a random access procedure involving Msg3 repetition, at S610, in a system information broadcast (e.g., in SIB1). The information includes information for configuring an initial UL bandwidth part (e.g., in a BWP-UplinkCommon IE). This information includes, amongst other things:
information for configuring the RSRP threshold for Msg3 repetition (e.g., in a rsrp-ThresholdMsg3 IE);
information for configuring the list of four possible numbers of repetitions for Msg3 repetition (e.g., in a numberOfMsg3-RepetitionsList IE);
information for configuring the set of MCS indexes for Msg3 repetition (e.g., in a mcs-Msg3-Repetitions IE); and
information for configuring one or more sets of Msg3 repetition feature specific RACH configurations.

The information for configuring one or more sets of Msg3 repetition feature specific RACH configurations may, for example, be in the form of a list of feature-specific (or feature combination specific) RACH configurations (e.g., where the information defining each RACH configuration may be provided by a respective additionalRACH-Config IE of an AdditionalRACH-ConfigList IE). Each RACH configuration may include common RACH configuration information (e.g. in a RACH-ConfigCommon IE) that includes information for configuring (e.g., in a featureCombinationPreambles IE) a set of preambles specifically associated with a feature combination (e.g., indicated by a featureCombination IE) including an indication/flag indicating that that the Msg3 repetition feature is at least part of the feature combination associated with that set of preambles (e.g., by means of a msg3-Repetitions IE being set to true).

The system information provided at S610 may configure both one or more sets of random access resources associated with the Msg3 repetition indication and one or more sets of random access resources that are not associated with the Msg3 repetition indication. It will be appreciated that at another time the system information provided at S610 may configure only one or more sets of random access resources associated with the Msg3 repetition indication, or only one or more sets of random access resources that are not associated with the Msg3 repetition indication.

At S612, a contention-based random access procedure is triggered at the UE 3. Where the system information provided at S610 configures both one or more sets of random access resources associated with the Msg3 repetition indication, and one or more sets of random access resources that are not associated with the Msg3 repetition indication the UE 3 will perform a comparison of an RSRP estimated/measured at the UE 3 (e.g. an RSRP of a downlink pathloss reference) with the configured RSRP threshold for Msg3 repetition.

If the RSRP is less than (or no greater than) the threshold (as indicated at S614-1) then Msg3 repetition is determined to be applicable (Case 1), and the corresponding procedure indicated by steps S616-1 to S620-1 is followed.

Specifically, the UE 3 selects a Msg3 repetition specific preamble and sends this to the RAN 8 at S616-1. The RAN 8 responds with an RAR (Msg2) at S618-1 indicating the number of repetition times (e.g., reusing two bits of an MCS field of the UL grant to indicate one of the four possible values configured by the system information). The UE 3 interprets the repurposed bits accordingly and transmits, at S620-1, Msg3 on the PUSCH using resources indicated by the UL grant in the RAR message with an appropriate number of repetitions (as illustrated by the dashed arrows).

If the RSRP is no less than (or greater than) the threshold (as indicated at S614-2) then Msg3 repetition is determined not to be applicable (Case 2), and the corresponding procedure indicated by steps S616-2 to S620-2 is followed.

Specifically, the UE 3 selects a preamble that is not associated with the Msg3 feature indication and sends this to the RAN 8 at S616-2. The RAN 8 responds with an RAR (Msg2) at S618-2. In this case the RAR does not indicate a number of repetition times. The UE 3 interprets the bits of the MCS field as normal and transmits, at S620-2, Msg3 on the PUSCH using resources indicated by the UL grant in the RAR message without repetition.

It will be appreciated that if the system information provided at S610 only configures (for the BWP selected for the random-access procedure) one or more sets of random access resources associated with the Msg3 repetition indication, then the UE 3 may assume that Msg3 repetition is applicable for the current random access procedure. Similarly, if the system information provided at S610 only configures (for the BWP selected for the random-access procedure) one or more sets of random access resources that are not associated with the Msg3 repetition indication, then the UE 3 may assume that Msg3 repetition is not applicable for the current random access procedure.

Random Access Procedure for Msg3 Repetition (with Distance (or TA) Based Threshold)

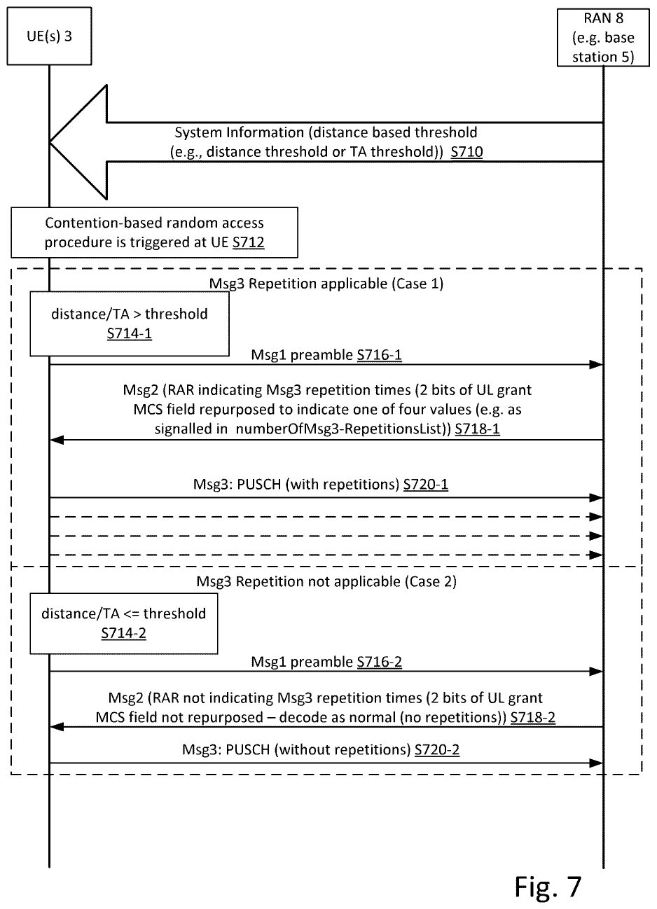

A random access procedure involving use of an additional threshold for determining when to use Msg3 repetition will now be described, by way of example only, with reference to FIG. 7, which is a simplified sequence diagram illustrating another random access procedure involving possible Msg3 repetition that may be used in the communication system 1.

As seen in FIG. 7 the RAN 8 configures the UE 3 with appropriate information for performing a random access procedure involving Msg3 repetition, at S710, in a system information broadcast (e.g., in SIB1). The information may include the information for configuring an initial UL bandwidth part (e.g., in a BWP-UplinkCommon IE) described with reference to FIG. 6. For example, as in FIG. 6, the information may include: the information for configuring the RSRP threshold for Msg3 repetition; the information for configuring the list of four possible numbers of repetitions for Msg3 repetition; the information for configuring the set of MCS indexes for Msg3 repetition; and the information for configuring one or more sets of Msg3 repetition feature specific RACH configurations. In this example, however, the system information also configures one or more additional thresholds for Msg3 repetition. Specifically, the system information also configures one or more distance related thresholds (e.g., one or more distance thresholds and/or one or more timing advance (TA) thresholds) for Msg3 repetition.

At S712, a contention-based random access procedure is triggered at the UE 3. Where the system information provided at S710 configures at least one or more sets of random access resources associated with the Msg3 repetition indication (and possibly one or more sets of random access resources that are not associated with the Msg3 repetition indication) the UE 3 will determine whether Msg3 repetition is applicable based on one or more configured distance based thresholds.

For example, if the distance based threshold is a distance, then the UE 3 may compare an estimated distance to a reference position/cell centre to the configured distance threshold. If the estimated distance is greater than (or no less than) the distance threshold the UE 3 may determine that Msg3 repetition is applicable (Case 1), and the corresponding procedure indicated by steps S716-1 to S720-1 followed. Otherwise (as indicated at S714-2), the UE 3 may determine that Msg3 repetition is not applicable (Case 2), and the corresponding procedure indicated by steps S716-2 to S720-2 followed.

If the distance based threshold is a TA value, then the UE 3 may compare an estimated TA to the configured TA threshold. If the estimated distance greater than (or no less than) the TA threshold the UE 3 may determine that Msg3 repetition is applicable (Case 1), and the corresponding procedure indicated by steps S716-1 to S720-1 followed. Otherwise (as indicated at S714-2), the UE 3 may determine that Msg3 repetition is not applicable (Case 2), and the corresponding procedure indicated by steps S716-2 to S720-2 followed.

The UE 3 may estimate the distance to the reference position/TA at the time of msg3 transmission, or following a base station to UE round-trip-time (RTT) measurement, and use this estimated distance/TA to compare with the threshold (this is especially useful for an earth moving cell). Alternatively, a positive or negative distance/TA delta can be configured/added to a current distance/TA estimate (depending on relative movement of the cell centre towards or away from the UE) and the UE 3 can use the resulting value for comparison with the configured threshold.

If it is determined that that Msg3 repetition is applicable (Case 1), then the UE 3 selects a Msg3 repetition specific preamble and sends this to the RAN 8 at S716-1. The RAN 8 responds with an RAR (Msg2) at S718-1 indicating the number of repetition times (e.g., reusing two bits of an MCS field of the UL grant to indicate one of the four possible values configured by the system information). The UE 3 interprets the repurposed bits accordingly and transmits, at S720-1, Msg3 on the PUSCH using resources indicated by the UL grant in the RAR message with an appropriate number of repetitions (as illustrated by the dashed arrows).

Otherwise if it is determined that that Msg3 repetition is not applicable (Case 2), then the UE 3 selects a preamble that is not associated with the Msg3 feature indication and sends this to the RAN 8 at S716-2. The RAN 8 responds with an RAR (Msg2) at S718-2. In this case the RAR does not indicate a number of repetition times. The UE 3 interprets the bits of the MCS field as normal and transmits, at S720-2, Msg3 on the PUSCH using resources indicated by the UL grant in the RAR message without repetition.

It will be appreciated that the RSRP may, optionally, also be used in addition to the distance based threshold to determine if Msg3 repetition is applicable. For example, Msg3 repetition may be determined to be applicable: if both the RSRP AND the distance/RA, when compared to their respective thresholds indicate that Msg3 repetition is applicable; or if either the RSRP OR the distance/RA, when compared to their respective thresholds, indicate that Msg3 repetition is applicable.

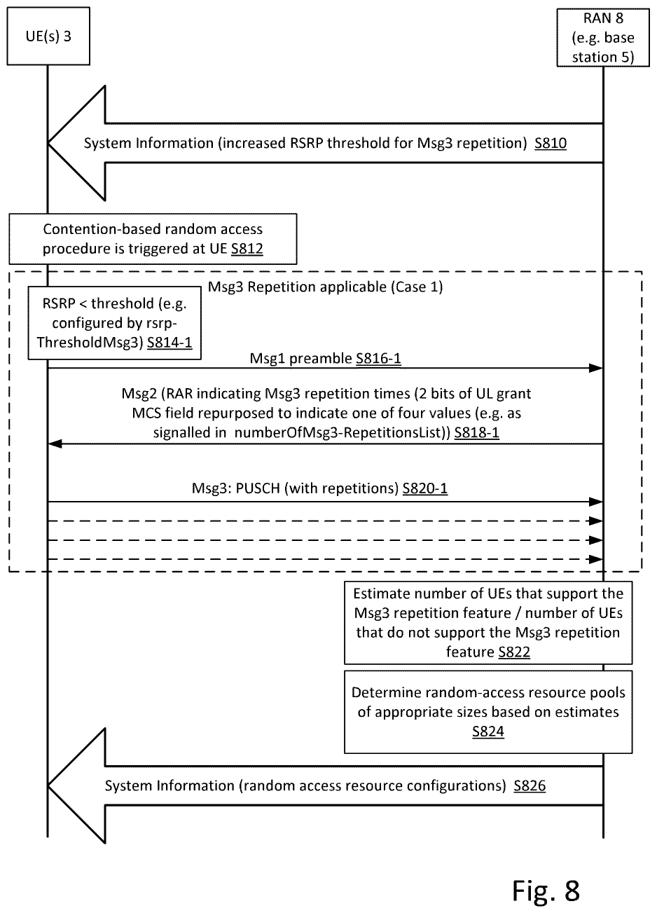

Random access procedure for Msg3 Repetition (with increased RSRP threshold) A random access procedure involving use of an increased RSRP threshold for determining when to use Msg3 repetition will now be described, by way of example only, with reference to FIG. 8, which is a simplified sequence diagram illustrating another random access procedure involving possible Msg3 repetition that may be used in the communication system 1.

As seen in FIG. 8 the RAN 8 configures the UE 3 with appropriate information for performing a random access procedure involving Msg3 repetition, at S810, in a system information broadcast (e.g., in SIB1). The information may include the information for configuring an initial UL bandwidth part (e.g., in a BWP-UplinkCommon IE) described with reference to FIG. 6. For example, as in FIG. 6, the information may include: the information for configuring the RSRP threshold for Msg3 repetition; the information for configuring the list of four possible numbers of repetitions for Msg3 repetition; the information for configuring the set of MCS indexes for Msg3 repetition; and the information for configuring one or more sets of Msg3 repetition feature specific RACH configurations. In this example, however, the network, via the system information, configures the RSRP threshold for Msg3 repetition to be greater than the (expected) RSRP that all UEs in the cell's coverage will measure.

At S812, a contention-based random access procedure is triggered at the UE 3. Where the system information provided at S810 configures at least one or more sets of random access resources associated with the Msg3 repetition indication (and possibly both one or more sets of random access resources associated with the Msg3 repetition indication and one or more sets of random access resources that are not associated with the Msg3 repetition indication), the UE 3 will perform a comparison of an RSRP estimated/measured at the UE 3 (e.g. an RSRP of a downlink pathloss reference) with the configured increased RSRP threshold for Msg3 repetition.

Because of the increased RSRP threshold, the RSRP will (almost always) be less than the threshold (as indicated at S814-1) and Msg3 repetition will be determined to be applicable (Case 1). The corresponding procedure indicated by steps S816-1 to S820-1 will, therefore, almost always be followed by a UE 3 that supports RSRP based Msg3 repetition.

Specifically, the UE 3 selects a Msg3 repetition specific preamble and sends this to the RAN 8 at S816-1. The RAN 8 responds with an RAR (Msg2) at S818-1 indicating the number of repetition times (e.g., reusing two bits of an MCS field of the UL grant to indicate one of the four possible values configured by the system information). The UE 3 interprets the repurposed bits accordingly and transmits, at S820-1, Msg3 on the PUSCH using resources indicated by the UL grant in the RAR message with an appropriate number of repetitions (as illustrated by the dashed arrows).

Accordingly, regardless of the RSRP seen at the UE 3, any UE 3 that supports RSRP based Msg3 repetition (or at least a significant majority of such UEs) will select random access resources from the resource pool associated with the RSRP based Msg3 repetition feature indication. The RAN equipment can assume that there is a static (stable) ratio between the number of UEs that support the Msg3 repetition feature and the number of UEs that do not support the Msg3 repetition feature and estimate the numbers of UEs that support/do not support Msg3 repetition (as S822). The RAN equipment can thus respectively determine an appropriate random access resource pool size for the number of UEs that support the Msg3 repetition feature and the number of UEs that do not support the Msg3 repetition feature (as S824) and provide random access resource configurations accordingly (at S826).

### Random Access Procedure for Msg3 Repetition (Range Based Random Access Resource Sets)

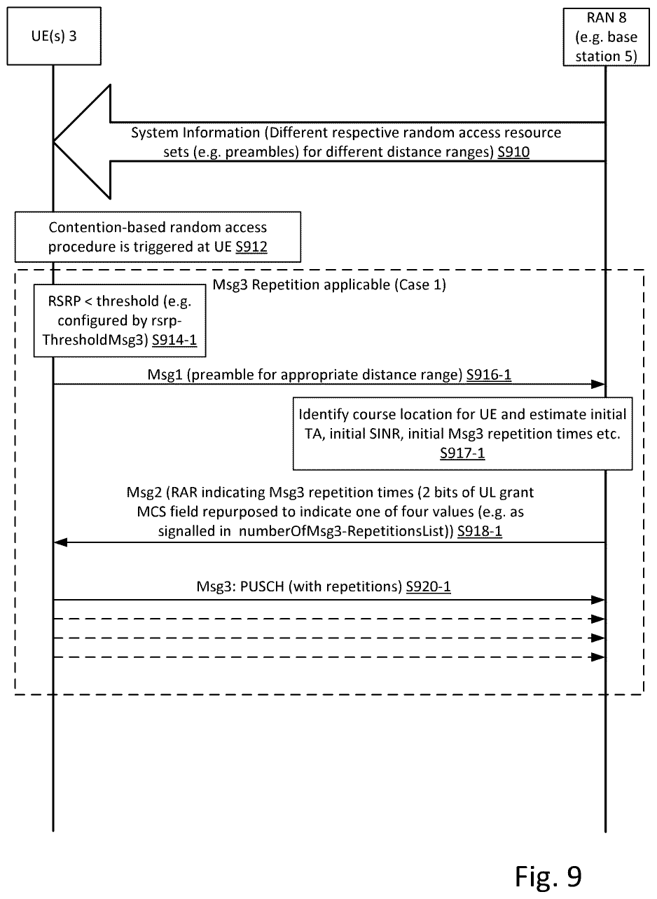

A random access procedure involving use of range based random access resource sets will now be described, by way of example only, with reference to FIG. 9, which is a simplified sequence diagram illustrating another random access procedure involving possible Msg3 repetition that may be used in the communication system 1.

As seen in FIG. 9 the RAN 8 configures the UE 3 with appropriate information for performing a random access procedure involving Msg3 repetition, at S910, in a system information broadcast (e.g., in SIB1). The information may include the information for configuring an initial UL bandwidth part (e.g., in a BWP-UplinkCommon IE) described with reference to FIG. 6. For example, as in FIG. 6, the information may include: the information for configuring the RSRP threshold for Msg3 repetition; the information for configuring the list of four possible numbers of repetitions for Msg3 repetition; the information for configuring the set of MCS indexes for Msg3 repetition; and the information for configuring one or more sets of Msg3 repetition feature specific RACH configurations. In this example, however, the system information also configures multiple random access resource sets for use by the UE 3 for different distance ranges (e.g. relative to a reference position/cell centre). Each configured resource set may be associated with a respective distance range that may be defined, for example by a minimum and a maximum distance (e.g., using mindistance and maxdistance IEs or the like).

At S912, a contention-based random access procedure is triggered at the UE 3. Where the system information provided at S910 configures at least one or more sets of random access resources associated with the Msg3 repetition indication (and possibly both one or more sets of random access resources associated with the Msg3 repetition indication and one or more sets of random access resources that are not associated with the Msg3 repetition indication), the UE 3 will perform a comparison of an RSRP estimated/measured at the UE 3 (e.g. an RSRP of a downlink pathloss reference) with the configured RSRP threshold for Msg3 repetition.

If the RSRP is less than (or no greater than) the threshold (as indicated at S914-1) then Msg3 repetition is determined to be applicable (Case 1), and the corresponding procedure indicated by steps S916-1 to S920-1 is followed.

Specifically, the UE 3 selects a Msg3 repetition specific preamble that is specific to the distance range within which the UE 3 is located and sends this to the RAN 8 at S916-1. Accordingly, the RAN 8 can determine (e.g. at S917-1 and/or at another time) the UE's coarse location, and then estimate the UE's initial TA, initial SINR, initial Msg3 repetition times and so on.

The RAN 8 responds to the Msg1 transmission with an RAR (Msg2) at S918-1 indicating the number of repetition times (e.g., reusing two bits of an MCS field of the UL grant to indicate one of the four possible values configured by the system information). The UE 3 interprets the repurposed bits accordingly and transmits, at S920-1, Msg3 on the PUSCH using resources indicated by the UL grant in the RAR message with an appropriate number of repetitions (as illustrated by the dashed arrows).

If the RSRP is no less than (or greater than) the threshold, then Msg3 repetition is determined not to be applicable (Case 2), and the corresponding procedure indicated by steps S616-2 to S620-2 in FIG. 6 may be followed.

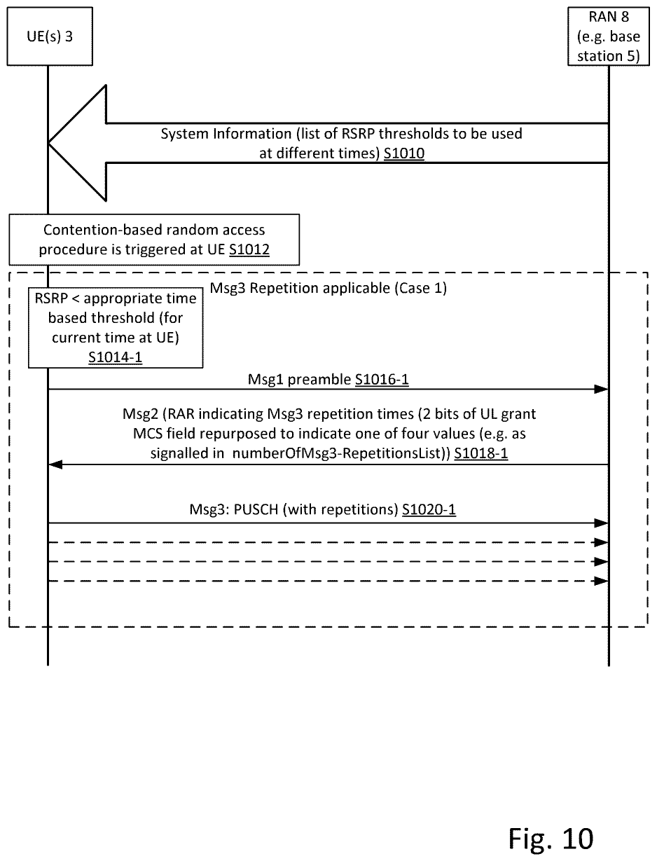

Random access procedure for Msg3 Repetition (plural RSRP thresholds) A random access procedure involving use of a list of RSRP thresholds will now be described, by way of example only, with reference to FIG. 10, which is a simplified sequence diagram illustrating another random access procedure involving possible Msg3 repetition that may be used in the communication system 1.

As seen in FIG. 10 the RAN 8 configures the UE 3 with appropriate information for performing a random access procedure involving Msg3 repetition, at S1010, in a system information broadcast (e.g., in SIB1). The information may include the information for configuring an initial UL bandwidth part (e.g., in a BWP-UplinkCommon IE) described with reference to FIG. 6. For example, as in FIG. 6, the information may include: the information for configuring the RSRP threshold for Msg3 repetition; the information for configuring the list of four possible numbers of repetitions for Msg3 repetition; the information for configuring the set of MCS indexes for Msg3 repetition; and the information for configuring one or more sets of Msg3 repetition feature specific RACH configurations. In this example, however, the information for configuring the RSRP threshold for Msg3 repetition configures a list of RSRP threshold, where each threshold is associated with a different respective time or time period.

For example, the RAN equipment may configure each RSRP threshold in the list of RSRP thresholds in association with a respective time window [t1-t2]. Alternatively, in a variation on this, the RAN equipment may configure each RSRP threshold in the list of RSRP thresholds in association with a respective time, Tx, for each RSRP threshold.

At S1012, a contention-based random access procedure is triggered at the UE 3. Where the system information provided at S910 configures at least one or more sets of random access resources associated with the Msg3 repetition indication (and possibly both one or more sets of random access resources associated with the Msg3 repetition indication and one or more sets of random access resources that are not associated with the Msg3 repetition indication), the UE 3 will perform a comparison of an RSRP estimated/measured at the UE 3 (e.g. an RSRP of a downlink pathloss reference) with an appropriate RSRP threshold from the list of RSRP thresholds (or calculated based on an RSRP threshold from the list of RSRP thresholds) for a current time measured at the UE 3.

For example, the UE 3 may use an RSRP threshold from the list that has an associated time window [t1-t2] within which the current time measured at the UE 3 falls. Alternatively, the UE 3 can use the RSRP threshold with the corresponding time Tx that is closest to a current time measured at UE 3 or a calculated RSRP threshold for the current measured time using linear function based on Tx, the corresponding RSRP threshold, and the current time.

If the RSRP is less than (or no greater than) the RSRP threshold used at S1014-1 (as indicated at S1014-1) then Msg3 repetition is determined to be applicable (Case 1), and the corresponding procedure indicated by steps S1016-1 to S1020-1 is followed.

Specifically, the UE 3 selects a Msg3 repetition specific preamble and sends this to the RAN 8 at S1016-1. The RAN 8 responds with an RAR (Msg2) at S1018-1 indicating the number of repetition times (e.g., reusing two bits of an MCS field of the UL grant to indicate one of the four possible values configured by the system information). The UE 3 interprets the repurposed bits accordingly and transmits, at S1020-1, Msg3 on the PUSCH using resources indicated by the UL grant in the RAR message with an appropriate number of repetitions (as illustrated by the dashed arrows).

The RAN 8 responds to the Msg1 transmission with an RAR (Msg2) at S1018-1 indicating the number of repetition times (e.g., reusing two bits of an MCS field of the UL grant to indicate one of the four possible values configured by the system information). The UE 3 interprets the repurposed bits accordingly and transmits, at S1020-1, Msg3 on the PUSCH using resources indicated by the UL grant in the RAR message with an appropriate number of repetitions (as illustrated by the dashed arrows).

If the RSRP is no less than (or greater than) the threshold, then Msg3 repetition is determined not to be applicable (Case 2), and the corresponding procedure indicated by steps S616-2 to S620-2 in FIG. 6 may be followed.

### Enabling First Uplink Transmission Repetition for Contention Free Random Access Procedures

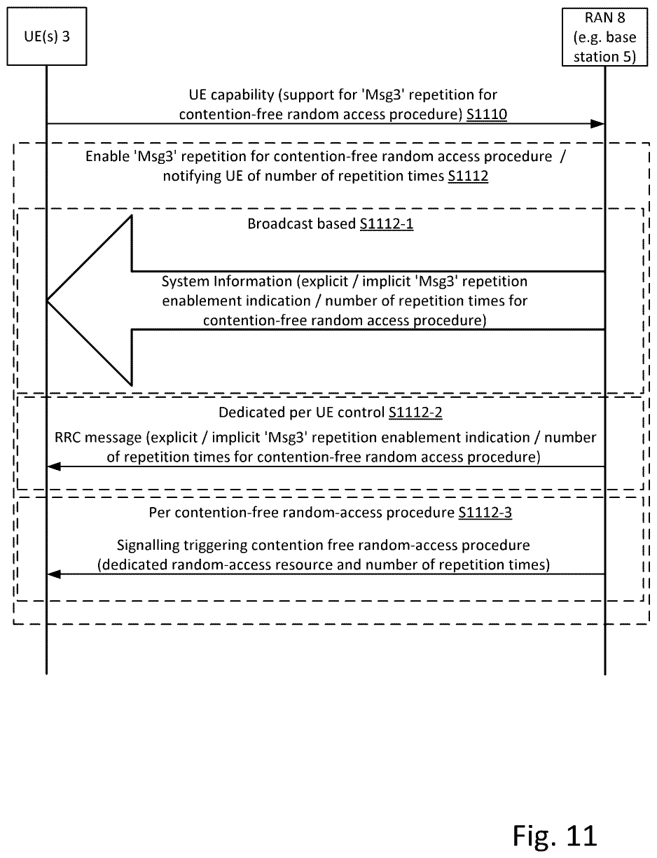

Options for enabling first uplink transmission repetition (referred to for simplicity as ‘Msg3’ repetition) for contention free random access procedures will now be described, by way of example only, with reference to FIG. 11, which is a simplified sequence diagram illustrating a number of options for enabling ‘Msg3’ repetition/indicating a number of repetitions for contention free random access that may be used in the communication system 1.

As seen in FIG. 11, to allow the RAN 8 to know that the UE 3 supports ‘Msg3’ repetition for contention free random access procedure the UE 3 reports its capability as S1110 (e.g., as UE capability information which may be sent in response to a UE capability enquiry from the RAN 8).

The RAN 8 can then enable ‘Msg3’ repetition for contention-free random access procedure and notify the UE 3 of the associated number of repetition times in any of a number of different ways (as indicated in box S1112).

As indicated at S1112-1, ‘Msg3’ repetition for contention-free random access procedures may be enabled either implicitly or explicitly using broadcast signalling. For example, a system information broadcast (e.g., SIB1) may include information indicating a number of repetitions for ‘Msg3’ (e.g., in dedicated IE such as a Msg3RepetitiontimesforContentionFree IE) that also serves to implicitly indicate that ‘Msg3’ repetition for contention-free random access procedures is enabled. Nevertheless, a separate dedicated ‘Msg3’ repetition for contention-free random access procedures enablement indication/flag may be included.

It will be appreciated that, in this broadcast based example, in addition to a serving RAN receiving the UE reported support for msg3 repetition for contention free random procedures, the capability may be made available to a target RAN (e.g. for handover) in which case the system information including the relevant information indicating a number of repetitions for ‘Msg3’ will be broadcast (e.g., at S1112-1) in the target cell.

Accordingly, when contention-free Random access is triggered by a PDCCH order, for a UE that has reported a Msg3 repetition for contention free random access procedures support capability, repetition is enabled by the system information broadcast in the serving cell (as seen at S1112-1). Msg3 repetition will then be applied for contention free transmission (i.e., the UE 3 will transmit Msg3 based on an UL grant received in an RAR for the configured number of times (e.g., the number of times configured by the Msg3RepetitiontimesforContentionFree IE).

When contention-free Random access is triggered by a handover or conditional handover a UE that has reported a Msg3 repetition for contention free random access procedures support capability, repetition is enabled by the system information broadcast in the target cell (as seen at S1112-1). Msg3 repetition will then be applied for contention free transmission (i.e., the UE 3 will transmit Msg3 based on an UL grant received in an RAR for the configured number of times (e.g., the number of times configured by the Msg3RepetitiontimesforContentionFree IE).

Considering that most contention free random access will happen when UE is going out of cell coverage (or experience a poor radio link), a fixed/cell-specific/BWP-specific number of repetition times may be sufficient in many cases.

As indicated at S1112-2, ‘Msg3’ repetition for contention-free random access procedures may be enabled either implicitly or explicitly using dedicated (e.g. RRC) signalling on a per UE basis. For example, one or more RRC messages (e.g., an RRCsetup and/or RRCReconfiguration message) may include information indicating a number of repetitions for ‘Msg3’ (e.g., in dedicated IE such as a Msg3RepetitiontimesforContentionFree IE) that also serves to implicitly indicate that ‘Msg3’ repetition for contention-free random access procedures is enabled. Nevertheless, a separate dedicated ‘Msg3’ repetition for contention-free random access procedures enablement indication/flag may be included.

It will be appreciated that the use of such dedicated ‘per UE’ signalling can improve flexibility as ‘Msg3’ repetition for contention free random access can be enabled/configured on a per UE basis.

As indicated at S1112-3, ‘Msg3’ repetition for contention-free random access procedures may be enabled/configured when a contention-free random access procedure is triggered (i.e., on a ‘per contention-free random-access procedure basis). For example, the number of repetition times can be indicated along with the dedicated random-access resource for a triggered contention-free random-access procedure in the signalling that triggers that contention-free random-access procedure (e.g., in a PDCCH order or handover command).

For a handover command, repetition times can be configured along with the handover command RRC signalling, whereas for the PDCCH order one or multiple bits may be repurposed to indicate the number of repetition times.

It will be appreciated that the use of such ‘per contention-free random access procedure’ based signalling can further improve flexibility as ‘Msg3’ repetition for contention free random access can be enabled/configured on per random-free access procedure/per RAR UL grant basis.

It will be appreciated that in any of the options shown in FIG. 11 a set of ‘Msg3’ repetition times for contention free random access may be configured (e.g., {1,4,8,16}) as opposed to a specific (fixed) number of repetitions. In this case the actual number of repetition times used for ‘Msg3’ can be indicated by one or multiple bits of the RAR UL grant (e.g., in a similar manner to that described earlier for contention based random-access procedures).

It will also be appreciated that whilst the different options shown for enabling ‘Msg3’ repetition for contention-free random access procedure and notifying the UE 3 of the associated number of repetition times may not all be implemented in the same system they are not mutually exclusive and so can be implemented in the same system if needed.

For example, dedicated ‘per UE control’ using RRC signalling (as shown at S1112-2) indicating a number of repetitions and/or ‘per contention-free random-access procedure’ signalling (as shown at S1112-3) indicating a number of repetitions may be used to override an earlier broadcast based indication for a specific UE 3 and/or for a specific contention-free random-access procedure. Similarly ‘per contention-free random-access procedure’ signalling (as shown at S1112-3) indicating a number of repetitions may be used to override an earlier indication provided by ‘per UE control’ using RRC signalling (as shown at S1112-2).

### Modifications and Alternatives

A detailed example embodiment has been described above. As those skilled in the art will appreciate, a number of modifications and alternatives can be made to the above example embodiments whilst still benefiting from the disclosure embodied therein.

It will be appreciated that description of features of and actions performed by a base station (or gNB), NTN nodes, and UEs may be applied equally to base stations and UEs that communicate in the terrestrial plane only (i.e. as part of a terrestrial RAN without features of an NTN RAN such as a gateway and space or airborne platform) as to base stations that communicate via a non-terrestrial plane.

Moreover, description of features of and actions performed by a base station (or gNB) apply equally to distributed type base stations as to non-distributed type base stations.

It will also be appreciated that whilst information elements having specific names have been described differently named information elements but having a similar purpose may be used.

In the above description, the UE, the NTN node (satellite/airborne platform), and the access network node (base station) are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the UE, to the NTN node (satellite/UAS platform), or to the access network node (base station) as a signal over a computer network, or on a recording medium. Further, the functionality performed by part, or all, of this software may be performed using one or more dedicated hardware circuits. However, the use of software modules is preferred as it facilitates the updating of the UE, the NTN node (satellite/UAS platform), or the access network node (base station) in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; moulds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & | Fleet Management |
| Tracing | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/ | Lighting |
| Control | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer | Digital photo frame |
| Devices | Digital camera |
| | eBook |

Further, the above-described UE categories are merely examples of applications of the technical ideas and example embodiments described in the present document. Needless to say, these technical ideas and example embodiments are not limited to the above-described UE and various modifications can be made thereto.

Each feature disclosed in this specification (which term includes the claims) and/or shown in the drawings may be incorporated in the disclosure independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a user equipment (UE), the method comprising: receiving, from an access network node:
first information for configuring at least one resource set for use when initiating a first type of random access procedure in which at least one uplink transmission scheduled during the random access procedure is repeatable, and
second information for configuring at least one condition to be met for initiation of the first type of random access procedure;
determining, based on whether or not the at least one condition is met, whether to initiate the first type of random access procedure or to initiate a second type of random access procedure in which the at least one uplink transmission scheduled during the random access procedure is not repeatable; and
in a case where the at least one condition is met, initiating the first type of random access procedure using at least one resource selected from the at least one resource set configured by the first information; and
in a case where the at least one condition is not met, initiating the second type of random access procedure using at least one other resource;
wherein the second information configures a plurality of different threshold values for at least one parameter or characteristic that is obtainable at the UE, and the determining determines whether the at least one condition is met based on a comparison of at least one obtained value for the at least one parameter or characteristic with at least one of the plurality of different thresholds.

### (Supplementary Note 2)

A method according to supplementary note 1, wherein the plurality of different threshold values includes at least one distance based threshold value for a parameter or characteristic that changes with a distance of the UE from a reference position relative to a cell or beam provided by the access network node.

### (Supplementary Note 3)

A method according to supplementary note 2, wherein the at least one distance based threshold value is a threshold value for the distance of the UE from the reference point.

### (Supplementary Note 4)

A method according to supplementary note 2, wherein the at least one distance based threshold value is a threshold value for a timing advance parameter.

### (Supplementary Note 5)

A method according to any of supplementary notes 2 to 4, wherein, the plurality of different threshold values further includes at least one reference signal received power (RSRP) threshold value for an RSRP that is measurable at the UE.

### (Supplementary Note 6)

A method according to supplementary note 5, wherein the determining determines whether the at least one condition is met using both the at least one RSRP threshold value and the at least one distance based threshold value.

### (Supplementary Note 7)

A method according to supplementary note 6, wherein the determining determines that the at least one condition is met when both a condition based on the at least one RSRP threshold value is met, and a condition based on the at least one distance based threshold value is met.

### (Supplementary Note 8)

A method according to supplementary note 6, wherein the determining determines that the at least one condition is met when either a condition based on the at least one RSRP threshold value is met, or a condition based on the at least one distance based threshold value is met.

### (Supplementary Note 9)

A method according to any preceding supplementary note, wherein the plurality of different threshold values includes a plurality of different reference signal received power (RSRP) threshold values for an RSRP that is measurable at the UE.

### (Supplementary Note 10)

A method according to supplementary note 9, wherein each of the plurality of different RSRP threshold values is respectively associated with a different time point or time period.

### (Supplementary Note 11)

A method according to supplementary note 10, further comprising selecting at least one RSRP threshold of the plurality of different RSRP thresholds that is associated with a time point or time period that corresponds to a measured time at the UE, wherein the determining determines whether the at least one condition is met based on the at least one RSRP threshold selected by the selecting.

### (Supplementary Note 12)

A method according to any preceding supplementary note, wherein the first information configures a plurality of different resource sets for use when initiating the first type of random access procedure and each resource set is respectively associated with a different distance range, and in the case where the at least one condition is met, the method further comprises identifying a resource set of the plurality of different resource sets that is associated with a distance range that includes an estimated distance of the UE from a reference position relative to a cell or beam provided by the access network node, and the initiating initiates the first type of random access procedure using at least one resource selected from the identified resource set.

### (Supplementary Note 13)

A method according to any preceding supplementary note, wherein, in a case where an initiated first type of random access procedure or initiated second type of random access procedure fails, and a further random access procedure is to be initiated, the method further comprises redetermining, based on whether or not the at least one condition is still met, whether to initiate the further random access procedure as the first type of random access procedure or to initiate the further random access procedure as the second type of random access procedure; and
in a case where the at least one condition is met, initiating the further random access procedure as the first type of random access procedure using at least one resource reselected from the at least one resource set configured by the first information; and
in a case where the at least one condition is not met, initiating the further random access procedure as the second type of random access procedure using at least one other resource.

### (Supplementary Note 14)

A method performed by a user equipment (UE), the method comprising: receiving, from an access network node:
first information for configuring a plurality of different resource sets for use when initiating a first type of random access procedure in which at least one uplink transmission scheduled during the random access procedure is repeatable, wherein each resource set is respectively associated with a different distance range, and
second information for configuring at least one condition to be met for initiation of the first type of random access procedure;
determining, based on whether or not the at least one condition is met, whether to initiate the first type of random access procedure or to initiate a second type of random access procedure in which the at least one uplink transmission scheduled during the random access procedure is not repeatable; and
in a case where the at least one condition is met, identifying a resource set of the plurality of different resource sets that is associated with a distance range that includes an estimated distance of the UE from a reference position relative to a cell or beam provided by the access network node, and initiating the first type of random access procedure using at least one resource selected from the identified resource set; and
in a case where the at least one condition is not met, initiating the second type of random access procedure using at least one other resource.

### (Supplementary Note 15)

A method performed by a user equipment (UE), the method comprising: receiving, from an access network node:
first information for configuring at least one resource set for use when initiating a first type of random access procedure in which at least one uplink transmission scheduled during the random access procedure is repeatable, and
second information for configuring at least one condition to be met for initiation of the first type of random access procedure, the second information indicating a value for a reference signal received power (RSRP) threshold; and
determining, based on a comparison of a measured RSRP value with the value of the RSRP threshold indicated by the second information, whether the at least one condition is met; and
in a case where the at least one condition is met, initiating the first type of random access procedure using at least one resource selected from the at least one resource set configured by the first information; and
in a case where the at least one condition is not met, initiating a second type of random access procedure, in which the at least one uplink transmission scheduled during the random access procedure is not repeatable, using at least one other resource;
wherein the second information indicates a value for the RSRP threshold that is higher than a maximum value of RSRP expected to be measured by any UE in a cell operated by the access network node.

### (Supplementary Note 16)

A method performed by a user equipment (UE), the method comprising:
transmitting, to an access network node, information identifying a capability of the UE to support a contention-free random access procedure in which at least one uplink transmission scheduled during the contention-free random access procedure is repeatable; and
receiving, from the access network node, information indicating that repetition of an uplink transmission scheduled during a contention-free random access procedure is enabled.

### (Supplementary Note 17)

A method according to supplementary note 16, wherein the information indicating that repetition of an uplink transmission scheduled during a contention-free random access procedure is enabled comprises information for configuring a number of times the uplink transmission is to be repeated.

### (Supplementary Note 18)

A method according to supplementary note 17, wherein the information for configuring a number of times the uplink transmission is to be repeated indicates a plurality of possible repetition numbers and the method further comprises identifying the number of times the uplink transmission is to be repeated from the plurality of possible repetition numbers.

### (Supplementary Note 19)

A method according to supplementary note 18, wherein the number of times the uplink transmission is to be repeated is identified from the plurality of possible repetition numbers based on further information received from the access network node during the contention-free random access procedure.

### (Supplementary Note 20)

A method according to any of supplementary notes 16 to 19, wherein the information indicating that repetition of an uplink transmission scheduled during a contention-free random access procedure is enabled is received in a system information broadcast.

### (Supplementary Note 21)

A method according to any of supplementary notes 16 to 19, wherein the information indicating that repetition of an uplink transmission scheduled during a contention-free random access procedure is enabled is received in a dedicated message for the UE.

### (Supplementary Note 22)

A method according to any of supplementary notes 16 to 19, wherein the information indicating that repetition of an uplink transmission scheduled during a contention-free random access procedure is enabled is received in a message for triggering the contention-free random access procedure at the UE.

### (Supplementary Note 23)

A method performed by an access network node, the method comprising: transmitting, to a user equipment (UE):
first information for configuring at least one resource set for use when initiating a first type of random access procedure in which at least one uplink transmission scheduled during the random access procedure is repeatable, and
second information for configuring at least one condition to be met for initiation of the first type of random access procedure, wherein the second information configures a plurality of different threshold values for at least one parameter or characteristic that is obtainable at the UE; and
receiving, from the UE:
in a case where the at least one condition is met, a message initiating the first type of random access procedure using at least one resource selected from the at least one resource set configured by the first information; and
in a case where the at least one condition is not met, a message initiating a second type of random access procedure, in which the at least one uplink transmission scheduled during the random access procedure is not repeatable, using at least one other resource.

### (Supplementary Note 24)

A method performed by an access network node, the method comprising: transmitting, to a user equipment (UE):
first information for configuring a plurality of different resource sets for use when initiating a first type of random access procedure in which at least one uplink transmission scheduled during the random access procedure is repeatable, wherein each resource set is respectively associated with a different distance range, and
second information for configuring at least one condition to be met for initiation of the first type of random access procedure; and
receiving, from the UE:
in a case where the at least one condition is met, a message initiating the first type of random access procedure using at least one resource selected from a resource set of the plurality of different resource sets that is associated with a distance range that includes an estimated distance of the UE from a reference position relative to a cell or beam provided by the access network node; and
in a case where the at least one condition is not met, a message initiating a second type of random access procedure, in which the at least one uplink transmission scheduled during the random access procedure is not repeatable, using at least one other resource.

### (Supplementary Note 25)

A method performed by an access network node, the method comprising: transmitting, to a user equipment (UE):
first information for configuring at least one resource set for use when initiating a first type of random access procedure in which at least one uplink transmission scheduled during the random access procedure is repeatable, and
second information for configuring at least one condition to be met for initiation of the first type of random access procedure, the second information indicating a value for a reference signal received power (RSRP) threshold, wherein the second information indicates a value for the RSRP threshold that is higher than a maximum value of RSRP expected to be measured by any UE in a cell operated by the access network node; and
receiving, from the UE, a message initiating the first type of random access procedure using at least one resource selected from the at least one resource set configured by the first information.

### (Supplementary Note 26)

A method performed by an access network node, the method comprising:
receiving, from a user equipment (UE), information identifying a capability of the UE to support a contention-free random access procedure in which at least one uplink transmission scheduled during the contention-free random access procedure is repeatable; and
transmitting, to the UE, information indicating that repetition of an uplink transmission scheduled during a contention-free random access procedure is enabled.

### (Supplementary Note 27)

A user equipment (UE) comprising:
means for receiving, from an access network node:
first information for configuring at least one resource set for use when initiating a first type of random access procedure in which at least one uplink transmission scheduled during the random access procedure is repeatable, and
second information for configuring at least one condition to be met for initiation of the first type of random access procedure;
means for determining, based on whether or not the at least one condition is met, whether to initiate the first type of random access procedure or to initiate a second type of random access procedure in which the at least one uplink transmission scheduled during the random access procedure is not repeatable;
means for initiating, in a case where the at least one condition is met, the first type of random access procedure using at least one resource selected from the at least one resource set configured by the first information; and
means for initiating, in a case where the at least one condition is not met, the second type of random access procedure using at least one other resource;
wherein the second information configures a plurality of different threshold values for at least one parameter or characteristic that is obtainable at the UE, and the means for determining is configured to determine whether the at least one condition is met based on a comparison of at least one obtained value for the at least one parameter or characteristic with at least one of the plurality of different thresholds.

### (Supplementary Note 28)

A user equipment (UE) comprising:
means for receiving, from an access network node:
first information for configuring a plurality of different resource sets for use when initiating a first type of random access procedure in which at least one uplink transmission scheduled during the random access procedure is repeatable, wherein each resource set is respectively associated with a different distance range, and
second information for configuring at least one condition to be met for initiation of the first type of random access procedure;
means for determining, based on whether or not the at least one condition is met, whether to initiate the first type of random access procedure or to initiate a second type of random access procedure in which the at least one uplink transmission scheduled during the random access procedure is not repeatable;
means for identifying, in a case where the at least one condition is met, a resource set of the plurality of different resource sets that is associated with a distance range that includes an estimated distance of the UE from a reference position relative to a cell or beam provided by the access network node, and for initiating the first type of random access procedure using at least one resource selected from the identified resource set; and
means for initiating, in a case where the at least one condition is not met, the second type of random access procedure using at least one other resource.

### (Supplementary Note 29)

A user equipment (UE) comprising:
means for receiving, from an access network node:
first information for configuring at least one resource set for use when initiating a first type of random access procedure in which at least one uplink transmission scheduled during the random access procedure is repeatable, and
second information for configuring at least one condition to be met for initiation of the first type of random access procedure, the second information indicating a value for a reference signal received power (RSRP) threshold; and
means for determining, based on a comparison of a measured RSRP value with the value of the RSRP threshold indicated by the second information, whether the at least one condition is met;
means for initiating, in a case where the at least one condition is met, the first type of random access procedure using at least one resource selected from the at least one resource set configured by the first information; and
means for initiating, in a case where the at least one condition is not met, a second type of random access procedure, in which the at least one uplink transmission scheduled during the random access procedure is not repeatable, using at least one other resource;
wherein the second information indicates a value for the RSRP threshold that is higher than a maximum value of RSRP expected to be measured by any UE in a cell operated by the access network node.

### (Supplementary Note 30)

A user equipment (UE) comprising:
means for transmitting, to an access network node, information identifying a capability of the UE to support a contention-free random access procedure in which at least one uplink transmission scheduled during the contention-free random access procedure is repeatable; and
means for receiving, from the access network node, information indicating that repetition of an uplink transmission scheduled during a contention-free random access procedure is enabled.

### (Supplementary Note 31)

An access network node comprising:
means for transmitting, to a user equipment (UE):
first information for configuring at least one resource set for use when initiating a first type of random access procedure in which at least one uplink transmission scheduled during the random access procedure is repeatable, and
second information for configuring at least one condition to be met for initiation of the first type of random access procedure, wherein the second information configures a plurality of different threshold values for at least one parameter or characteristic that is obtainable at the UE; and
means for receiving, from the UE:
in a case where the at least one condition is met, a message initiating the first type of random access procedure using at least one resource selected from the at least one resource set configured by the first information; and
in a case where the at least one condition is not met, a message initiating a second type of random access procedure, in which the at least one uplink transmission scheduled during the random access procedure is not repeatable, using at least one other resource.

### (Supplementary Note 32)

An access network node comprising:
means for transmitting, to a user equipment (UE):
first information for configuring a plurality of different resource sets for use when initiating a first type of random access procedure in which at least one uplink transmission scheduled during the random access procedure is repeatable, wherein each resource set is respectively associated with a different distance range, and
second information for configuring at least one condition to be met for initiation of the first type of random access procedure; and
means for receiving, from the UE:
in a case where the at least one condition is met, a message initiating the first type of random access procedure using at least one resource selected from a resource set of the plurality of different resource sets that is associated with a distance range that includes an estimated distance of the UE from a reference position relative to a cell or beam provided by the access network node; and
in a case where the at least one condition is not met, a message initiating a second type of random access procedure, in which the at least one uplink transmission scheduled during the random access procedure is not repeatable, using at least one other resource.

### (Supplementary Note 33)

An access network node comprising:
means for transmitting, to a user equipment (UE):
first information for configuring at least one resource set for use when initiating a first type of random access procedure in which at least one uplink transmission scheduled during the random access procedure is repeatable, and
second information for configuring at least one condition to be met for initiation of the first type of random access procedure, the second information indicating a value for a reference signal received power (RSRP) threshold, wherein the second information indicates a value for the RSRP threshold that is higher than a maximum value of RSRP expected to be measured by any UE in a cell operated by the access network node; and
means for receiving, from the UE, a message initiating the first type of random access procedure using at least one resource selected from the at least one resource set configured by the first information.

### (Supplementary Note 34)

An access network node comprising:
means for receiving, from a user equipment (UE), information identifying a capability of the UE to support a contention-free random access procedure in which at least one uplink transmission scheduled during the contention-free random access procedure is repeatable; and
means for transmitting, to the UE, information indicating that repetition of an uplink transmission scheduled during a contention-free random access procedure is enabled.

This application is based upon and claims the benefit of priority from Great Britain Patent Application No. 2216395.0, filed on Nov. 3, 2022, the disclosure of which is incorporated herein in its entirety by reference.

### REFERENCE SIGNS LIST

1 COMMUNICATION SYSTEM
3 USER EQUIPMENT
5 gNB
7 CORE NETWORK
8 NTN (R)AN
9 GATEWAY
11 SPACE OR AIR BORNE PLATFORM
31 TRANSCEIVER CIRCUIT
33 AIR INTERFACE
35 USER INTERFACE
37 CONTROLLER
39 MEMORY
41 OPERATING SYSTEM
43 COMMUNICATIONS CONTROL MODULE
45 BWP MANAGEMENT MODULE
47 MEASUREMENT MANAGEMENT MODULE
49 UE CAPABILITY INFORMATION MODULE
50 PRACH MODULE
51 TRANSCEIVER CIRCUIT
53 AIR INTERFACE
55 CORE NETWORK INTERFACE
57 CONTROLLER
59 MEMORY
61 OPERATING SYSTEM
63 COMMUNICATIONS CONTROL MODULE
65 BWP MANAGEMENT MODULE
67 MEASUREMENT MANAGEMENT MODULE
71 UE CAPABILITY INFORMATION MODULE
51-1b TRANSCEIVER CIRCUIT
51-2b TRANSCEIVER CIRCUIT
53-2b AIR INTERFACE
55-1b NETWORK INTERFACE
57-1b CU CONTROLLER
57-2b DU CONTROLLER
59-1b CU MEMORY
59-2b DU MEMORY
61-1b CU OPERATING SYSTEM
61-2b DU OPERATING SYSTEM
63-1b CU COMMUNICATIONS CONTROL MODULE
63-2b DU COMMUNICATIONS CONTROL MODULE
65-1b BWP MANAGEMENT MODULE
65-2b BWP MANAGEMENT MODULE
67-2b MEASUREMENT MANAGEMENT MODULE
67-1b MEASUREMENT MANAGEMENT MODULE
71-1b PRACH MANAGEMENT MODULE
71-2b PRACH MANAGEMENT MODULE

What is claimed is:

1. A method performed by a mobile device, the method comprising:
receiving, from an access network node, information for configuring at least one condition for determining whether the mobile device is applicable for message 3 (Msg3) repetition of a random access procedure; and
determining whether the mobile device is applicable for the Msg3 repetition of the random access procedure, based on the configured at least one condition.

2. The method according to claim 1, wherein
the at least one condition is configured to adjust a number of mobile devices which are applicable of the Msg3 repetition and which are served by the access network node.

3. The method according to claim 1, wherein
the at least one condition includes a first condition whether a distance of the mobile device from a reference position corresponding to a cell or a beam provided by the access network node, is below a first threshold value.

4. The method according to claim 1, wherein
the at least one condition includes a second condition whether a timing advance value of the mobile device for a cell or a beam provided by the access network node, is below a second threshold value.

5. The method according to claim 3, wherein
the at least one condition includes a third condition whether a reference signal received power (RSRP) measured by the mobile device is below a third threshold, and
the determining is performed by using the third condition and the first condition.

6. The method according to claim 3, wherein
the at least one condition includes a third condition whether a reference signal received power (RSRP) measured by the mobile device is below a third threshold, and
the determining is performed by using the first condition.

7. The method according to claim 1, wherein
the at least one condition includes a third condition whether a reference signal received power (RSRP) measured by the mobile device is below a third threshold, and
the third threshold is higher so that a ratio of numbers of mobile devices supporting the Msg3 repetition and not supporting the Msg3 repetition is stable.

8. The method according to claim 1, wherein
the at least one condition includes a third condition whether a reference signal received power (RSRP) measured by the mobile device is below one of a plurality of third thresholds.

9. The method according to claim 8, wherein
each of the plurality of the thresholds is respectively corresponding to a time point or time period.

10. The method according to claim 9, further comprising
selecting a fourth threshold of the plurality of the thresholds corresponding to a time point or time period that corresponds to a time when the mobile device measured, and wherein
the determining includes determining using the fourth threshold.

11. The method according to claim 1, further comprising:
receiving, from the access network node, further information for configuring a plurality of resource sets for use by transmitting a request for the Msg3 repetition, wherein
each of the plurality of the resource sets is respectively corresponding to a range for a distance of the mobile device from a reference position corresponding to a cell or a beam provided by the access network node, and
the method further comprises:
determining a resource set of the plurality of the resource sets corresponding to a range including an estimated distance of the mobile device from a reference position corresponding to a cell or beam provided by the access network node, and
transmitting the request for the Msg3 repetition using at least one resource in the resource set.

12. The method according to claim 1, further comprising:
in a case where the random access procedure fails, and a further random access procedure is to be initiated, redetermining, based on whether or not the at least one condition is still met, whether to initiate the further random access procedure.

13. The method according to claim 1, wherein
the random access procedure is a contention-free random access procedure, and
the method further comprises:
transmitting, to the access network node, first information indicating a capability of the mobile device to support the Msg3 repetition of the contention-free random access procedure; and
receiving, from the access network node, second information indicating that the Msg3 repetition during the contention-free random access procedure is applicable.

14. The method according to claim 13, wherein
the second information includes third information for configuring a number of times Msg3 is to be repeated.

15. The method according to claim 14, wherein
the third information indicates a plurality of possible repetition numbers, and
the method further comprises determining the number of times Msg3 is to be repeated from the plurality of possible repetition numbers.

16. The method according to claim 15, wherein
the number of times Msg3 is to be repeated is determined from the plurality of possible repetition numbers based on further information received from the access network node during the contention-free random access procedure.

17-19. (canceled)

20. The method according to claim 1, wherein
the access network node is included in a non-terrestrial network.

21. A method performed by an access network node, the method comprising:
transmitting, to a mobile device, information for configuring at least one condition for determining whether the mobile device is applicable for message 3 (Msg3) repetition of a random access procedure, wherein
the information causes the mobile device to determine whether the mobile device is applicable for the Msg3 repetition of the random access procedure, based on the configured at least one condition.

22. A mobile device comprising:
at least one memory storing instructions; and
at least one processor configured to process the instructions to:
receive, from an access network node information for configuring at least one condition for determining whether the mobile device is applicable for message 3 (Msg3) repetition of a random access procedure; and
determine whether the mobile device is applicable for the Msg3 repetition of the random access procedure, based on the configured at least one condition.

23. An access network node comprising:
at least one memory storing instructions; and
at least one processor configured to process the instructions to:
transmit, to a mobile device information for configuring at least one condition for determining whether the mobile device is applicable for message 3 (Msg3) repetition of a random access procedure, wherein
the information causes the mobile device to determine whether the mobile device is applicable for the Msg3 repetition of the random access procedure, based on the configured at least one condition.
